(19) United States
(12) Patent Application Publication
(10) Pub. No.: US 2022/0282064 A1
(43) Pub. Date: Sep. 8, 2022

(54) STABILIZER COMPOSITION

(71) Applicant: BASF SE, Ludwigshafen am Rhein (DE)

(72) Inventors: Nancy N Cliff, Tarrytown, NY (US); Gregor Huber, Kaisten (SW); Gerard Finnegan, Tarrytown, NY (US)

(21) Appl. No.: 17/629,684

(22) PCT Filed: Jul. 30, 2019
(86) PCT No.: PCT/US2020/043977

§ 371 Date: Jan. 24, 2022

Related U.S. Application Data
(60) Provisional application No. 62/880,407, filed on Jul. 30, 2019.

(51) Int. Cl. C08K 5/3492; C08K 5/527; C08K 5/53; C08K 5/372; C08K 5/105

(52) U.S. Cl. CPC C08K 5/34924; C08K 5/527; C08K 5/53; C08K 5/372; C08K 5/105

(57) ABSTRACT

Disclosed herein are a plastic article exhibiting long term stability at elevated temperatures of about 150° C., resistance to degradation under UV and visible light exposure and resistance to discoloration upon exposure to fumes (such as the kind originating from other vehicles or during warehouse storage). Also disclosed herein are stabilizer additive compositions that may be incorporated into a plastic article to effectuate said performance.

### RELATED APPLICATIONS

This application is a National Stage 371 application that claims priority to International Application Number PCT/US2020/04377, filed Jul. 29, 2020 which claims priority to U.S. Provisional Patent Application No. 62/880,407, filed Jul. 30, 2019, which is herein incorporated by reference in its entirety.

### TECHNICAL FIELD

The present disclosure relates to stabilizer compositions used in the automotive industry.

### BACKGROUND

Performance requirements for polymers used in the automotive industry continue to evolve to higher and higher standards. These requirements include thermal stability tests designed to predict long term performance of polymer compositions for components of automotive interiors (long term thermal stability); resistance to degradation under UV and visible light exposure (weathering); and resistance to discoloration upon exposure to exhaust fumes originating from other vehicles or during warehouse storage (gas fade).

Consumer demands for longer-lasting interior components have resulted in increased testing temperature requirements in thermal stability evaluations, which are now frequently as high as 150° C.

It has proven challenging to meet the combination of properties specified above—long term thermal stability, weathering, and gas fade. The main technical challenges arise from the requirement to pass higher temperature thermal stability requirements, while also performing well in both gas fade and weathering, as well as maintaining good stability during extrusion and molding. The ability to achieve this is limited by the temperature ranges under which the various stabilizer types are effective.

For example, phenolic antioxidants are effective throughout a broad range of temperatures, and could be used to meet both processing and long term thermal requirements at 150° C. However, they perform poorly in gas fade at the concentrations required for the thermal stability.

Hindered Amine Light Stabilizers (HALS) perform well in gas fade and weathering, but are not very effective at the higher long term thermal stability temperatures.

High Molecular weight oligomeric Hindered Amine Light Stabilizers (HALS) improve weathering, and long term thermal stability at temperatures up to 135° C., but have limited usefulness at higher temperatures.

Hydroxyl amines and phosphites are effective processing stabilizers that could eliminate the need for phenolic antioxidants that cause gas fade issues; however, they are not effective under long term thermal conditions.

Thioesters are effective stabilizers for long term oxidative stability at both moderate and high (150° C.) temperatures, especially when used in combination with phenolic antioxidants. However, they are known to have a detrimental effect on weatherability, especially when used in combination with Hindered Amine Light Stabilizers.

### SUMMARY

Because of the above limitations, a stabilizer additive composition, comprising a combination of various stabilizers, that could meet the combination of properties specified above (long term thermal stability, weathering, and gas fade) was sought. Accordingly, in some embodiments, this disclosure is directed to a stabilizer additive composition comprising a thioester additive, a phenolic antioxidant, and a phosphite stabilizer. In some embodiments, this disclosure is directed to a stabilizer additive composition comprising a thioester additive and a Hindered Amine Light Stabilizer (HALS). In some embodiments, this disclosure is directed to a stabilizer additive composition comprising, a thioester additive, HALS, and at least one of a phenolic antioxidant and/or a phosphite stabilizer.

In some embodiments, this disclosure is directed to a plastic article that comprises a thermoplastic olefin substrate and a stabilizer additive composition incorporated in the thermoplastic olefin substrate, wherein the stabilizer additive composition comprises a thioester additive, a phenolic antioxidant, and a phosphite stabilizer. In some embodiments, this disclosure is directed to a plastic article that comprises a thermoplastic olefin substrate and a stabilizer additive composition incorporated in the thermoplastic olefin substrate, wherein the stabilizer additive composition comprises a thioester additive and a HALS. In some embodiments, this disclosure is directed to a plastic article that comprises a thermoplastic olefin substrate and a stabilizer additive composition incorporated in the thermoplastic olefin substrate, wherein the stabilizer additive composition comprises a thioester additive, a HALS, and at least one of phenolic antioxidant and/or a phosphite stabilizer. In some embodiments, the plastic article described herein exhibits at least two of the following: long-term thermal stability at a temperature of about 150° C., resistance to degradation under UV and visible light exposure (weathering), and resistance to discoloration upon exposure to exhaust fumes, such as the kind originating from exhaust from other vehicles or during warehouse storage (gas fade tests). In some embodiments, the plastic article described herein exhibits all of the following three: long-term thermal stability at a temperature of about 150° C., resistance to degradation under UV and visible light exposure (weathering), and resistance to discoloration upon exposure to exhaust fumes, such as the kind originating from exhaust from other vehicles or during warehouse storage (gas fade tests).

In some embodiments, this disclosure is directed to a process for making a stabilizer additive composition by combining a thioester additive, a phenolic antioxidant, and a phosphite stabilizer. In some embodiments, this disclosure is directed to a process for making a stabilizer additive composition by combining a thioester additive and HALS. In some embodiments, this disclosure is directed to a process for making a stabilizer additive composition by combining a thioester additive, HALS, and at least one of a phenolic antioxidant and/or a phosphite stabilizer.

In some embodiments, this disclosure is directed to a process of making a plastic article by incorporating any of the stabilizer additive compositions described herein into a thermoplastic olefin substrate. In some embodiments the plastic article may be further made by extrusion and/or molding.

### DETAILED DESCRIPTION

In certain embodiments, the instant disclosure may be directed to a plastic article comprising a thermoplastic olefin substrate and a stabilizer additive composition incorporated in the thermoplastic olefin substrate. In certain embodiments, the stabilizer additive composition incorporated into the thermoplastic olefin substrate may comprise a thioester additive, a phenolic antioxidant, and a phosphite stabilizer. In certain embodiments, the stabilizer additive composition incorporated into the thermoplastic olefin substrate may comprise a thioester additive and HALS. In certain embodiments, the stabilizer additive composition incorporated into the thermoplastic olefin substrate may comprise a thioester additive, HALS, and at least one of a phenolic antioxidant and/or a phosphite stabilizer.

In certain embodiments, the plastic article may be solid. The term “solid” as used herein refers to an article that does not have a cavity in its center and is not prepared by a process that would generate a cavity in the article (e.g., rotomolding). In certain embodiments, the plastic article may be an automotive component.

### Thermoplastic Olefin Substrate

In certain embodiments, a thermoplastic olefin substrate may comprise a thermoplastic, an elastomer, and a filler. Exemplary thermoplastics include, without limitations, polyethylene, polypropylene, block copolymers thereof, and the like. Exemplary elastomers include, without limitations, ethylene propylene rubber (EPR), ethylene propylene diene rubber (EPDM), ethylene-octene (EO), ethylbenzene (EB), styrene ethylene butadiene styrene (SEBS), and the like. Exemplary fillers include, without limitations, talc, fiberglass, carbon fiber, wollastonite, metal oxy sulfate, and the like.

Polyethylene that may be included in the thermoplastic olefin substrate includes, for example, high density polyethylene (HDPE), high molecular weight high density polyethylene (HMW HDPE), ultrahigh molecular weight high density polyethylene (UHMW HDPE), medium density polyethylene (MDPE), low density polyethylene (LDPE), linear low density polyethylene (LLDPE), branched low density polyethylene (BLDPE), ethylene-propylene-diene terpolymers (EPDM), mixtures of polyethylene with polypropylene (PP), polyethylenes and ethylene copolymers prepared using Phillips catalysts, polyethylene blends, or a mixture thereof. Ethylene copolymers may contain differing proportions of comonomers. In some embodiments, comonomers include 1-olefins such as propene, 1-butene, 1-pentene, 1-hexene, 1-heptene, 1-octene or isobutylene, styrene, cycloolefins such as cyclopentene, cyclohexene or norbornene or dienes such as butadiene, isoprene, 1,4-hexadiene, cyclopentadiene, dicyclopentadiene, norbornadiene or ethylidenenorbornene. In certain embodiments, polymers can be linear or branched and can be formulated with or without crosslinking (e.g., chemical crosslinking).

In certain embodiments, polymers can be a copolymer or a homopolymer. In one embodiment, the polymer substrate is a homopolymer. In another embodiment, the polymer substrate is a copolymer.

The thermoplastic olefin may have other polymers incorporated therein, for example polystyrene, polyamide, polyester, polycarbonate, epoxy resins, polyurethane, copolymers thereof (e.g., random or block copolymers) or mixtures thereof. In some embodiments, such “other” polymers may be present in a finished article from any of about 1 wt % (weight percent), about 2 wt %, about 3 wt %, about 4 wt %, about 5 wt %, about 6 wt % or about 7 wt % to any of about 8 wt %, about 9 wt %, about 10 wt %, about 11 wt %, about 12 wt %, about 13 wt %, about 14 wt % or about 15 wt %, based on the total weight of the finished article.

### Stabilizer Additive Composition

In certain embodiments, the stabilizer additive composition comprises a thioester additive. Thioether additives may include for example mercaptan-containing compounds. In some embodiments, mercaptan-containing compounds contain one or more, for instance 1, 2, 3 or 4 moieties of chemical structure:

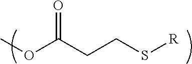

wherein R is a C₆-C₁₈ hydrocarbyl.

In some embodiments, the hydrocarbyl group in the above chemical structure for the mercaptan-containing compound may be a C₆-C₁₆ hydrocarbyl group, C₈-C₁₄ hydrocarbyl group, a C₁₀-C₁₃ hydrocarbyl group, or a C₁₂ hydrocarbyl group. Hydrocarbyl is any hydrocarbon containing group, for example straight or branched chain alkyl or alkenyl which may be interrupted by or substituted by one or more heteroatom-containing groups or aryl groups, for instance interrupted by one or more —O—, —NH— or —C(O)O— groups and/or substituted by one or more hydroxyl, carboxylic, amino, thiol, phosphonate or aryl groups. Aryl includes phenyl. In some embodiments, hydrocarbyl may be nonyl, dodecyl, decyl, undecyl, lauryl (dodecyl) or tridecyl.

Alkyl groups may be linear or branched and may include 2-ethylbutyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, tert-octyl, 2-ethylhexyl, 1,1,3-trimethylhexyl, 1,1,3,3-tetramethylpentyl, nonyl, decyl, undecyl, 1-methylundecyl, dodecyl and octadecyl. Alkenyl is salkyl containing an ethylenically unsaturated group.

In one embodiment, the thioester may comprise dioctadecyl 3,3′-thiodipropionate (CAS No. 693-36-7), referred to herein as “thioester 1,” with the following chemical structure:

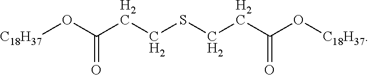

In one embodiment, the thioester additive may comprise 2,2-bis[[3-(dodecylthio)-1-oxopropoxy]methyl]propane-1,3-diyl bis [3-(dodecylthio)propionate] (CAS No. 29598-76-3), referred to herein as “thioester 2,” and have the following chemical structure:

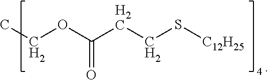

In one embodiments, the thioester may comprise a combination of thioester 1 and thioester 2.

Plastic articles described herein may in some embodiments comprise any of the thioether additives described herein at an amount ranging from about 0.01 wt % to about 0.5 wt %, from about 0.01 wt % to about 0.3 wt %, from about 0.01 wt % to about 0.2 wt %, from about 0.02 wt % to about 0.15 wt %, from about 0.02 wt % to about 0.22 wt %, from about 0.03 wt % to about 0.22 wt %, from about 0.03 wt % to about 0.18 wt %, from about 0.04 wt % to about 0.12 wt %, from about 0.05 wt % to about 0.3 wt %, from about 0.05 wt % to about 0.11 wt %, or from about 0.08 wt % to about 0.15 wt %, based on total weight of the plastic article. In certain embodiments, the thioester additive is present in the plastic article in an amount ranging from about 0.01 wt %, about 0.02 wt %, about 0.03 wt %, about 0.04 wt %, about 0.05 wt %, or about 0.06 wt % to about 0.07 wt %, about 0.08 wt %, about 0.09 wt %, about 0.1 wt %, about 0.11 wt %, about 0.12 wt %, about 0.13 wt %, about 0.14 wt %, about 0.15 wt %, about 0.16 wt %, about 0.17 wt %, about 0.18 wt %, about 0.19 wt %, about 0.20 wt %, about 0.21 wt %, about 0.22 wt %, about 0.25 wt %, about 0.30 wt %, about 0.35 wt %, about 0.40 wt %, about 0.45 wt %, or about 0.50 wt %, based on the total weight of the plastic article. Without being construed as limiting, it is believed that a moderate amount thioester additive enhances the long term thermal stability of a plastic article. However, it is believed that a high amount of thioester additive could compromise the weatherability of a plastic article. Accordingly, in certain embodiments, the thioester additive is present at a sufficient amount to enhance long term thermal stability of the plastic article with minimal adverse effect to the weatherability of the plastic article.

In certain embodiments, the instant disclosure may be directed to the stabilizer additive composition itself as a concentrated master batch. In a concentrated master batch of the stabilizer additive composition, the thioester additive may be present in an amount ranging from about 10 wt % to about 60 wt %, from about 20 wt % to about 50 wt %, from about 25 wt % to about 35 wt %, or any wt % value or range in between, based on total weight of the stabilizer additive composition. In certain embodiments, the thioester additive is present in the stabilizer additive composition in an amount ranging from about 10 wt %, about 12 wt %, about 14 wt %, about 16 wt %, about 18 wt %, about 20 wt %, about 22 wt %, about 24 wt %, about 26 wt %, about 28 wt %, or about 30 wt % to about 35 wt %, about 38 wt %, about 40 wt %, about 42 wt %, about 44 wt %, about 46 wt %, about 48 wt %, about 50 wt %, about 52 wt %, about 54 wt %, about 56 wt %, about 58 wt %, or about 60 wt %, based on the total weight of the stabilizer additive composition.

Various antioxidants may be used in the stabilizer additive composition described herein. Suitable antioxidants may include, without limitations, at least one of hindered phenolic antioxidants, organophosphorus stabilizers, dialkylhydroxylamine stabilizers, amine oxide stabilizers and tocopherols. In some embodiments, antioxidants include a combination of an organophosphorus stabilizer and a hindered phenolic antioxidant, a dialkylhydroxylamine stabilizer, a combination of an organophosphorus stabilizer and a dialkylhydroxylamine stabilizer, an amine oxide stabilizer or a combination of an organophosphorus stabilizer and an amine oxide stabilizer. In one embodiment, the antioxidants include a combination of a phenolic antioxidant and a phosphite stabilizer.

Antioxidants may also include vitamin E and vitamin E acetate (tocopherols). Each may be employed alone, in combination with each other, or in combination with one or more antioxidants selected from the group consisting of hindered phenolic antioxidants, dialkylhydroxylamine stabilizers, organophosphorus stabilizers and amine oxide stabilizers.

Hydroxylamine stabilizers that may be optionally included are, for example, N,N-dibenzylhydroxylamine, N,N-diethylhydroxylamine, N,N-dioctylhydroxyl amine, N,N-dilaurylhydroxylamine, N,N-didodecylhydroxylamine, N,N-ditetradecylhydroxylamine, N,N-dihexadecylhydroxylamine, N,N-dioctadecylhydroxylamine, N-hexadecyl-N-tetradecylhydroxylamine, N-hexadecyl-N-heptadecylhydroxylamine, N-hexadecyl-N-octadecylhydroxylamine, N-heptadecyl-N-octadecylhydroxylamine, N-methyl-N-octadecylhydroxylamine, N,N-di(C₁₆-C₁₈alkyl)hydroxylamine, or a combination thereof.

Organophosphorus stabilizers may include, without limitations, at least one of phosphite and phosphonite stabilizers, such as, triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di-tert-butylphenyl) phosphite, bis(2,4-di-α-cumylphenyl) pentaerythrtitol diphosphite, diisodecyl pentaerythritol diphosphite, bis(2,4-di-tert-butylphenyl) pentaerythritol diphosphite (D), bis(2,6-di-tert-butyl-4-methylphenyl) pentaerythritol diphosphite (E), bisisodecyloxy-pentaerythritol diphosphite, bis(2,4-di-tert-butyl-6-methylphenyl) pentaerythritol diphosphite, bis(2,4,6-tri-tert-butylphenyl) pentaerythritol diphosphite, tristearyl sorbitol triphosphite, tetrakis (2,4-di-tert-butylphenyl) 4,4′-biphenylene-diphosphonite (H), 6-isooctyloxy-2,4,8,10-tetra-tert-butyl-dibenzo[d,f][1,3,2]dioxaphosphepin (C), 6-fluoro-2,4,8,10-tetra-tert-butyl-12-methyl-dibenzo[d,g][1,3,2]dioxaphosphocin (A), bis(2,4-di-tert-butyl-6-methylphenyl) methyl phosphite, bis(2,4-di-tert-butyl-6-methylphenyl) ethyl phosphite (G), 2,2′,2″-nitrilo[triethyltris(3,3′5,5′-tetra-tert-butyl-1,1′-biphenyl-2,2′-diyl) phosphite] (B), bis(2,4-di-t-butylphenyl) octylphosphite, poly(4,4′-{2,2′-dimethyl-5,5′-di-t-butylphenylsulfide-}octylphosphite), poly(4,4′{-isopropylidenediphenol}-octylphosphite), poly(4,4′-{isopropylidenebis[2,6-dibromophenol]}-octylphosphite), poly(4,4′-{2,2′-dimethyl-5,5′-di-t-butylphenylsulfide}-pentaerythrityl diphosphite),

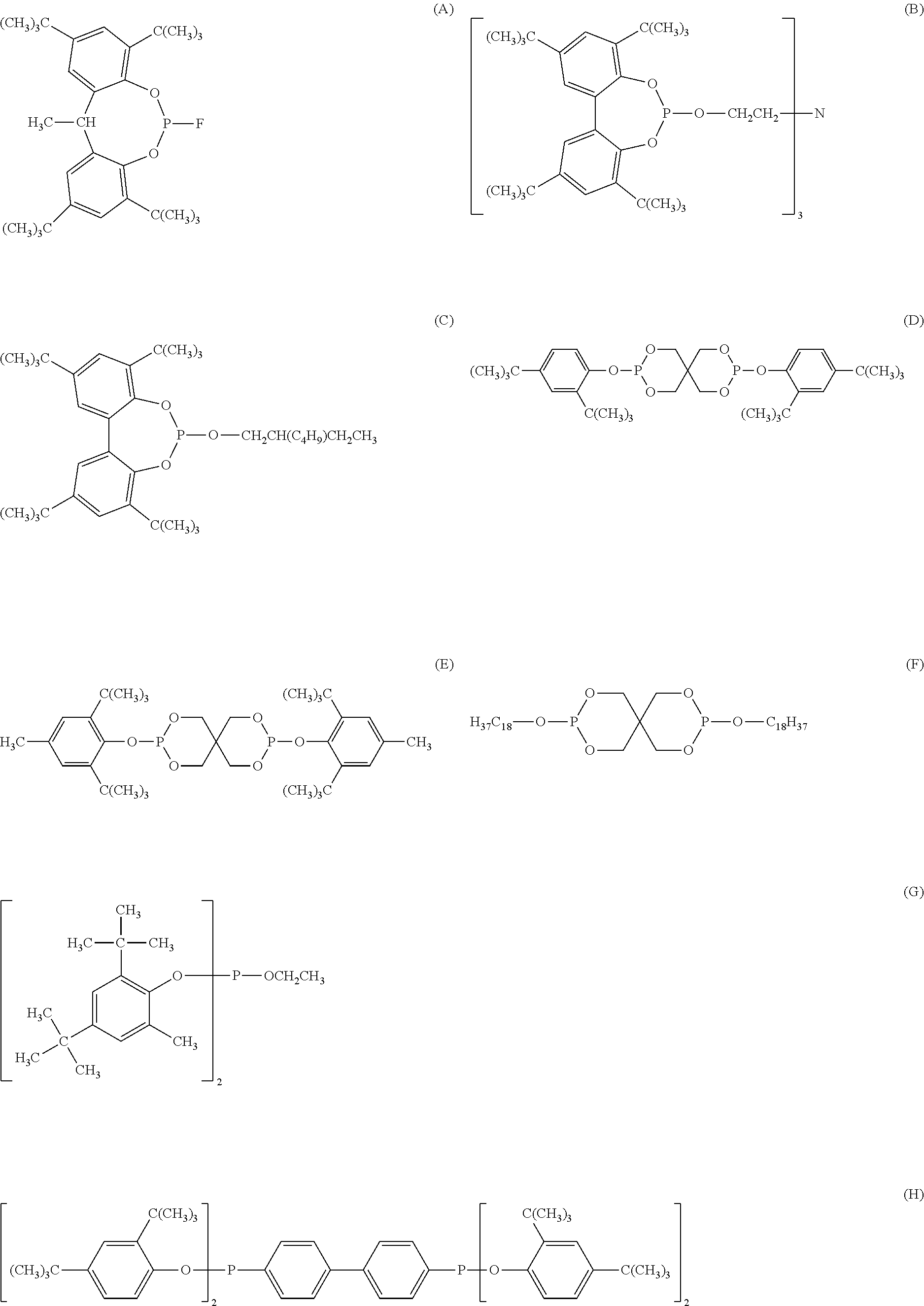

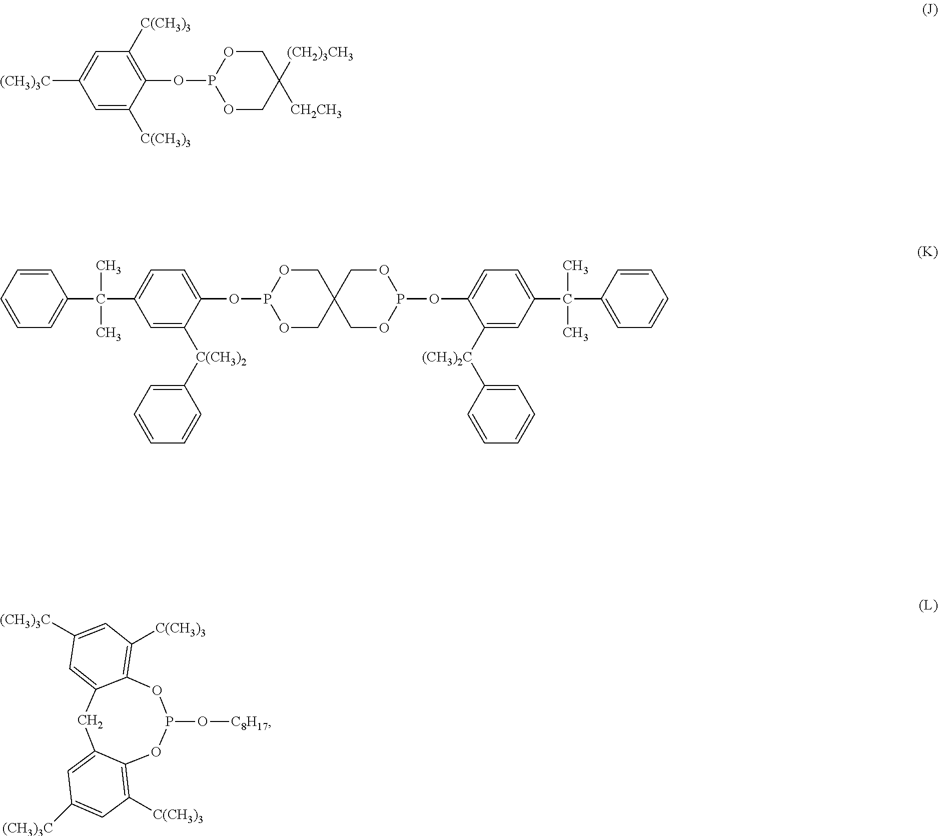

or a mixture thereof.

Suitable organophosphorus stabilizers may also be liquid stabilizers as disclosed in U.S. Pub. No. 2010/048782 and U.S. Pat. No. 7,888,414, for example liquid phosphites P-2, P-3 and P-4 therein, which are incorporated herein by reference. Suitable liquid organophosphorus stabilizers are also disclosed in U.S. Pub. Nos. 2013/0225736 and 2010/0029844 and U.S. Pat. Nos. 7,468,410 and 8,304,477, and are incorporated herein by reference.

In an embodiment, the stabilizer additive composition described herein comprises a phosphite stabilizer that is tris(2,4-di-tert-butylphenyl) (CAS No. 31570-04-4) and has the following chemical structure:

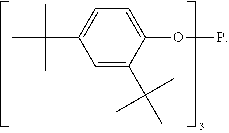

Plastic articles described herein may in some embodiments comprise any of the organophosphorus stabilizers described herein at an amount ranging from about 0.01 wt % to about 0.30 wt %, from about 0.02 wt % to about 0.4 wt %, from about 0.02 wt % to about 0.25 wt %, from about 0.03 wt % to about 0.2 wt %, from about 0.03 wt % to about 0.3 wt %, from about 0.02 wt % to about 0.15 wt %, from about 0.03 wt % to about 0.10 wt %, from about 0.04 wt % to about 0.06 wt %, or from about 0.05 wt % to about 0.2 wt %, or any wt % value or range in between, based on total weight of the plastic article. In certain embodiments, the organophosphorus stabilizer is present in the plastic article in an amount ranging from about 0.01 wt %, about 0.02 wt %, about 0.03 wt %, about 0.04 wt %, or about 0.05 wt % to about 0.06 wt %, about 0.07 wt %, about 0.08 wt %, about 0.09 wt %, about 0.10 wt %, about 0.11 wt %, about 0.12 wt %, about 0.13 wt %, about 0.14 wt %, about 0.15 wt %, about 0.16 wt %, about 0.17 wt %, about 0.18 wt %, about 0.19 wt %, about 0.2 wt %, about 0.21 wt %, about 0.22 wt %, about 0.23 wt %, about 0.24 wt %, about 0.25 wt %, about 0.26 wt %, about 0.27 wt %, about 0.28 wt %, about 0.29 wt %, about 0.30 wt %, about 0.32 wt %, about 0.34 wt %, about 0.36 wt %, about 0.38 wt %, or about 0.40 wt %, based on the total weight of the plastic article.

In certain embodiments, the instant disclosure may be directed the stabilizer additive composition itself as a concentrated master batch. In a concentrated master batch of the stabilizer additive composition, the organophosphorus stabilizer may be present in an amount ranging from about 10 wt % to about 60 wt %, from about 20 wt % to about 50 wt %, from about 25 wt % to about 35 wt %, or any wt % value or range in between, based on total weight of the stabilizer additive composition. In certain embodiments, the organophosphorus additive is present in the stabilizer additive composition in an amount ranging from about 10 wt %, about 12 wt %, about 14 wt %, about 16 wt %, about 18 wt %, about 20 wt %, about 22 wt %, about 24 wt %, about 26 wt %, about 28 wt %, or about 30 wt % to about 35 wt %, about 38 wt %, about 40 wt %, about 42 wt %, about 44 wt %, about 46 wt %, about 48 wt %, about 50 wt %, about 52 wt %, about 54 wt %, about 56 wt %, about 58 wt %, or about 60 wt %, based on the total weight of the stabilizer additive composition.

Suitable hindered phenolic antioxidants that may be incorporated in the stabilizer additive compositions of this disclosure, may include, without limitations, at least one of tris(3,5-di-tert-butyl-4-hydroxybenzyl) isocyanurate, 1,3,5-tris-(3,5-di-tert-butyl-4-hydroxybenzyl)-2,4,6-trimethylbenzene, the calcium salt of the monoethyl ester of 3,5-di-tert-butyl-4-hydroxybenzylphosphonic acid, pentaerythritol tetrakis [3-(3,5-di-tert-butyl-4-hydroxyphenyl) propionate], octadecyl 3-(3,5-di-tert-butyl-4-hydroxyphenyl) propionate, or a mixture thereof.

In one embodiment, the hindered phenolic antioxidant in the stabilizer additive composition described herein may comprise tris(3,5-di-tert-butyl-4-hydroxybenzyl (CAS No. 27676-62-6) and may have the following chemical structure:

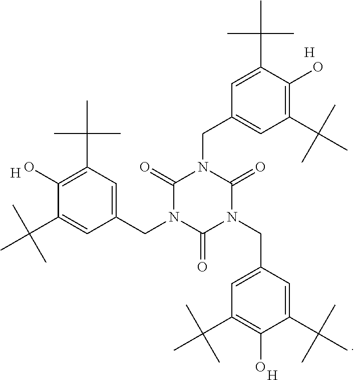

In one embodiments, the hindered phenolic antioxidant in the stabilizer additive composition described herein may comprise tetrakis [3-(3,5-di-tert-butyl-4-hydroxyphenyl) propionate] (CAS No. 6683-19-8), having the following chemical structure:

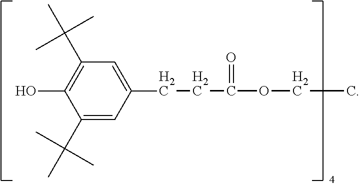

Plastic articles described herein may in some embodiments comprise any of the hindered phenolic antioxidants described herein at an amount ranging from about 0.01 wt % to about 0.3 wt %, from about 0.02 wt % to about 0.15 wt %, from about 0.03 wt % to about 0.10 wt %, from about 0.03 wt % to about 0.2 wt %, from about 0.05 wt % to about 0.1 wt %, or from about 0.04 wt % to about 0.06 wt %, or any wt % value or range in between, based on total weight of the plastic article. In certain embodiments, the hindered phenolic antioxidant is present in the plastic article in an amount ranging from about 0.01 wt %, about 0.02 wt %, about 0.03 wt %, about 0.04 wt %, or about 0.05 wt % to about 0.06 wt %, about 0.07 wt %, about 0.08 wt %, about 0.09 wt %, about 0.10 wt %, about 0.11 wt %, about 0.12 wt %, about 0.13 wt %, about 0.14 wt %, about 0.15 wt %, about 0.16 wt %, about 0.17 wt %, about 0.18 wt %, about 0.19 wt %, about 0.20 wt %, about 0.21 wt %, about 0.22 wt %, about 0.23 wt %, about 0.24 wt %, about 0.25 wt %, about 0.26 wt %, about 0.27 wt %, about 0.28 wt %, about 0.29 wt %, or about 0.30 wt %, based on the total weight of the plastic article.

In certain embodiments, the instant disclosure may be directed the stabilizer additive composition itself as a concentrated master batch. In a concentrated master batch of the stabilizer additive composition, the hindered phenolic antioxidant may be present in an amount ranging from about 10 wt % to about 60 wt %, from about 15 wt % to about 45 wt %, from about 20 wt % to about 30 wt %, or any wt % value or range in between, based on total weight of the stabilizer additive composition. In certain embodiments, the hindered phenolic antioxidant is present in the stabilizer additive composition in an amount ranging from about 10 wt %, about 12 wt %, about 14 wt %, about 16 wt %, about 18 wt %, about 20 wt %, about 22 wt %, about 24 wt %, about 26 wt %, about 28 wt %, or about 30 wt % to about 35 wt %, about 38 wt %, about 40 wt %, about 42 wt %, about 44 wt %, about 46 wt %, about 48 wt %, about 50 wt %, about 52 wt %, about 54 wt %, about 56 wt %, about 58 wt %, or about 60 wt %, based on the total weight of the stabilizer additive composition.

In an embodiment, the stabilizer additive composition may comprise a combination of i) a thioester additive having the following chemical structure:

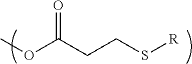

wherein R is a C₆-C₁₈ hydrocarbyl group, ii) a phenolic antioxidant, and iii) a phosphite stabilizer.

In an embodiment, the stabilizer additive composition may comprise a combination of
i) a thioester additive comprising 2,2-bis[[3-(dodecylthio)-1-oxopropoxy]methyl]propane-1,3-diyl bis[3-(dodecylthio)propionate] (CAS No. 29598-76-3) with the following chemical structure:

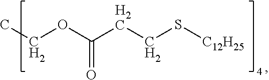

ii) a phenolic antioxidant comprising tris(3,5-di-tert-butyl-4-hydroxybenzyl (CAS No. 27676-62-6) and may have the following chemical structure:

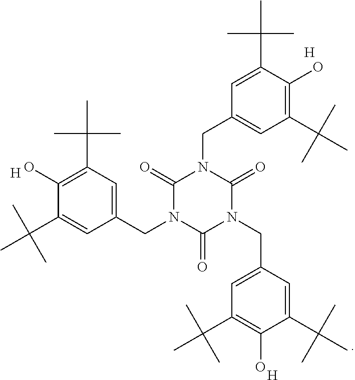

or pentaerythritol tetrakis [3-(3,5-di-tert-butyl-4-hydroxyphenyl) propionate] (CAS No. 6683-19-8), having the following chemical structure:

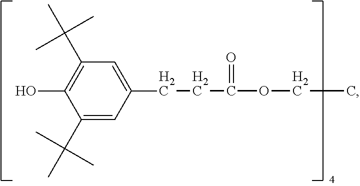

and
iii) a phosphite stabilizer comprising tris(2,4-di-tert-butylphenyl) (CAS No. 31570-04-4) and has the following chemical structure:

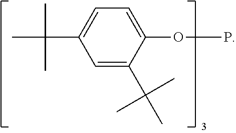

In an embodiment, the stabilizer additive composition may comprise a combination of
i) a thioester additive comprising 2 dioctadecyl 3,3′-thiodipropionate (CAS No. 693-36-7), referred to herein as “thioester 1,” with the following chemical structure:

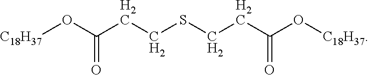

ii) a phenolic antioxidant comprising tris(3,5-di-tert-butyl-4-hydroxybenzyl (CAS No. 27676-62-6) and may have the following chemical structure:

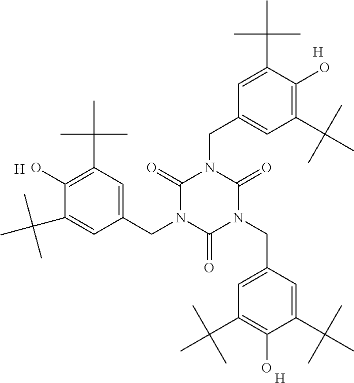

or pentaerythritol tetrakis [3-(3,5-di-tert-butyl-4-hydroxyphenyl) propionate] (CAS No. 6683-19-8), having the following chemical structure:

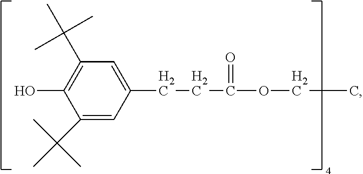

and
iii) a phosphite stabilizer comprising tris(2,4-di-tert-butylphenyl) (CAS No. 31570-04-4) and has the following chemical structure:

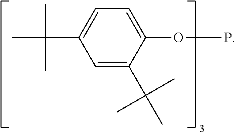

In certain embodiments, the weight/weight ratio of the thioester additive to the phenolic antioxidant in the stabilizer additive composition or in the plastic article may range from about 5:1 to about 1:5, from about 3:1 to about 1:3, or from about 2:1 to about 1:2, or any sub-range or single ratio value therein. In certain embodiments, the weight/weight ratio of the thioester additive to the phenolic antioxidant in the stabilizer additive composition or in the plastic article ranges from about 1:1 to about 3:1, from about 1:1 to about 2:1, or from about 2:1 to about 3:1. These weight/weight ratio ranges may apply to any of the thioester additives described herein and to any of the phenolic antioxidants described herein.

In certain embodiment, the weight/weight ratio of the thioester additive to the organophosphorus stabilizer (e.g., phosphite stabilizer) in the stabilizer additive composition or in the plastic article may range from about 5:1 to about 1:5, from about 3:1 to about 1:3, or from about 2:1 to about 1:2, or any sub-range or single ratio value therein. In certain embodiments, the weight/weight ratio of the thioester additive to the organophosphorus stabilizer (e.g., phosphite stabilizer) in the stabilizer additive composition or in the plastic article ranges from about 3:1 to about 1:2, from about 3:1 to about 1:1, from about 2:1 to about 1:1, from about 3:1 to about 2:1, or from about 1:1 to about 1:2. These weight/weight ratio ranges may apply to any of the thioester additives described herein and to any of the organophosphorus stabilizers described herein.

In certain embodiment, the weight/weight ratio of the phenolic antioxidant to the organophosphorus stabilizer (e.g., phosphite stabilizer) in the stabilizer additive composition or in the plastic article may range from about 5:1 to about 1:5, from about 3:1 to about 1:3, or from about 2:1 to about 1:2, or any sub-range or single ratio value therein. In certain embodiments, the weight/weight ratio of the phenolic antioxidant to the organophosphorus stabilizer (e.g., phosphite stabilizer) in the stabilizer additive composition or in the plastic article ranges from about 1:1 to about 1:2, from about 1:1 to about 1:3, or from about 1:2 to about 1:3. These weight/weight ratio ranges may apply to any of the phenolic antioxidant described herein and to any of the organophosphorus stabilizers described herein.

### Further Additives

In certain embodiments, the plastic articles described herein may comprise further additives.

An exemplary additive that may be incorporated into the plastic articles and/or into the stabilizer additive compositions disclosed herein may include hindered amine light stabilizers (HALS).

In certain embodiments, the plastic article or the additive compositions include any of the thioester additives described hereinbefore in combination with HALS. In certain embodiments, the plastic article or the additive compositions include any of the thioester additives described hereinbefore in combination with HALS and in combination with at least one of: any of the phenolic antioxidants described herein and/or any of the phosphite stabilizers described herein.

In certain embodiment, the weight/weight ratio of the phenolic antioxidant to the HALS in the stabilizer additive composition or in the plastic article may range from about 5:1 to about 1:5, from about 3:1 to about 1:3, or from about 2:1 to about 1:2, or any sub-range or single ratio value therein. In certain embodiments, the weight/weight ratio of the phenolic antioxidant to the HALS in the stabilizer additive composition or in the plastic article ranges from about 1:1 to about 1:2. These weight/weight ratio ranges may apply to any of the phenolic antioxidant described herein and to any of the HALS described herein.

In certain embodiment, the weight/weight ratio of the phosphite stabilizer to the HALS in the stabilizer additive composition or in the plastic article may range from about 5:1 to about 1:5, from about 3:1 to about 1:3, or from about 2:1 to about 1:2, or any sub-range or single ratio value therein. These weight/weight ratio ranges may apply to any of the phosphite stabilizers described herein and to any of the HALS described herein.

In certain embodiment, the weight/weight ratio of the thioester additive to the HALS in the stabilizer additive composition or in the plastic article may range from about 5:1 to about 1:5, from about 3:1 to about 1:3, or from about 2:1 to about 1:2, or any sub-range or single ratio value therein. In certain embodiments, the weight/weight ratio of the thioester additive to the HALS in the stabilizer additive composition or in the plastic article ranges from about 3:1 to about 1:2, about 3:1 to about 2:1, about 3:1 to about 1:1, about 2:1 to about 1:1, or about 1:1 to about 1:2. These weight/weight ratio ranges may apply to any of the thioester additives described herein and to any of the HALS described herein.

Suitable exemplary HALS are disclosed in US2015/0284535 and U.S. Pat. Nos. 5,004,770, 5,204,473, 5,096,950, 5,300,544, 5,112,890, 5,124,378, 5,145,893, 5,216,156, 5,844,026, 5,980,783, 6,046,304, 6,117,995, 6,271,377, 6,297,299, 6,392,041, 6,376,584 and 6,472,456, which are incorporated herein by reference.

Additional suitable HALS include, without limitations:
(1) 1-cyclohexyloxy-2,2,6,6-tetramethyl-4-octadecylaminopiperidine,
(2) bis(2,2,6,6-tetramethylpiperidin-4-yl) sebacate,
(3) bis(1-acetoxy-2,2,6,6-tetramethylpiperidin-4-yl) sebacate,
(4) bis(1,2,2,6,6-pentamethylpiperidin-4-yl) sebacate,
(5) bis(1-cyclohexyloxy-2,2,6,6-tetramethylpiperidin-4-yl) sebacate,
(6) bis(1-octyloxy-2,2,6,6-tetramethylpiperidin-4-yl) sebacate;
(7) bis(1-acyl-2,2,6,6-tetramethylpiperidin-4-yl) sebacate,
(8) bis(1,2,2,6,6-pentamethyl-4-piperidyl) n-butyl-3,5-di-tert-butyl-4-hydroxybenzylmalonate
(9) 2,4-bis[(1-cyclohexyloxy-2,2,6,6-tetramethylpiperidin-4-yl)butylamino]-6-(2-hydroxyethyl amino-s-triazine,
(10) bis(1-cyclohexyloxy-2,2,6,6-tetramethylpiperidin-4-yl) adipate,
(11) 2,4-bis[(1-cyclohexyloxy-2,2,6,6-piperidin-4-yl)butylamino]-6-chloro-s-triazine,
(12) 1-(2-hydroxy-2-methylpropoxy)-4-hydroxy-2,2,6,6-tetramethylpiperidine,
(13) 1-(2-hydroxy-2-methylpropoxy)-4-oxo-2,2,6,6-tetramethylpiperidine,
(14) 1-(2-hydroxy-2-methylpropoxy)-4-octadecanoyloxy-2,2,6,6-tetramethylpiperidine,
(15) bis(1-(2-hydroxy-2-methylpropoxy)-2,2,6,6-tetramethylpiperidin-4-yl) sebacate,
(16) bis(1-(2-hydroxy-2-methylpropoxy)-2,2,6,6-tetramethylpiperidin-4-yl) adipate,
(17) 2,4-bis {N-[1-(2-hydroxy-2-methylpropoxy)-2,2,6,6-tetramethylpiperidin-4-yl]-N-butyl-amino}-6-(2-hydroxyethylamino)-s-triazine,
(18) 4-benzoyl-2,2,6,6-tetramethylpiperidine,
(19) di-(1,2,2,6,6-pentamethylpiperidin-4-yl) p-methoxybenzylidenemalonate,
(20) 2,2,6,6-tetramethylpiperidin-4-yl octadecanoate,
(21) bis(1-octyloxy-2,2,6,6-tetramethylpiperidyl) succinate,
(22) 1,2,2,6,6-pentamethyl-4-aminopiperidine,
(23) 2-undecyl-7,7,9,9-tetramethyl-1-oxa-3,8-diaza-4-oxo-spiro[4,5]decane,
(24) tris(2,2,6,6-tetramethyl-4-piperidyl) nitrilotriacetate,
(25) tris(2-hydroxy-3-(amino-(2,2,6,6-tetramethylpiperidin-4-yl)propyl) nitrilotriacetate,
(26) tetrakis(2,2,6,6-tetramethyl-4-piperidyl)-1,2,3,4-butane-tetracarboxylate,
(27) tetrakis(1,2,2,6,6-pentamethyl-4-piperidyl)-1,2,3,4-butane-tetracarboxylate,
(28) 1,1′-(1,2-ethanediyl)-bis(3,3,5,5-tetramethylpiperazinone),
(29) 3-n-octyl-7,7,9,9-tetramethyl-1,3,8-triazaspiro[4.5]decan-2,4-dione,
(30) 8-acetyl-3-dodecyl-7,7,9,9-tetramethyl-1,3,8-triazaspiro[4.5]decane-2,4-dione,
(31) 3-dodecyl-1-(2,2,6,6-tetramethyl-4-piperidyl)pyrrolidin-2,5-dione,
(32) 3-dodecyl-1-(1,2,2,6,6-pentamethyl-4-piperidyl)pyrrolidine-2,5-dione,
(33) N,N′-bis-formyl-N,N′-bis(2,2,6,6-tetramethyl-4-piperidyl)hexamethylenediamine,
(33a) bis(1-undecanyloxy-2,2,6,6-tetramethylpiperidin-4-yl)carbonate,
(34) reaction product of 2,4-bis[(1-cyclohexyloxy-2,2,6,6-piperidin-4-yl)butylamino]-6-chloro-s-triazine with N,N′-bis(3-aminopropyl)ethylenediamine),
(35) condensate of 1-(2-hydroxyethyl)-2,2,6,6-tetramethyl-4-hydroxypiperidine and succinic acid,
(36) condensate of N,N′-bis(2,2,6,6-tetramethyl-4-piperidyl)-hexamethylenediamine and 4-tert-octylamino-2,6-dichloro-1,3,5-triazine,
(37) condensate of N,N′-bis(2,2,6,6-tetramethyl-4-piperidyl)-hexamethylenediamine and 4-cyclohexylamino-2,6-dichloro-1,3,5-triazine,
(38) condensate of N,N′-bis-(2,2,6,6-tetramethyl-4-piperidyl)hexamethylenediamine and 4-morpholino-2,6-dichloro-1,3,5-triazine,
(39) condensate of N,N′-bis-(1,2,2,6,6-pentamethyl-4-piperidyl)hexamethylenediamine and 4-morpholino-2,6-dichloro-1,3,5-triazine, (40) condensate of 2-chloro-4,6-bis(4-n-butylamino-2,2,6,6-tetramethylpiperidyl)-1,3,5-triazine and 1,2-bis(3-aminopropylamino)ethane,
(41) condensate of 2-chloro-4,6-di-(4-n-butylamino-1,2,2,6,6-pentamethylpiperidyl)-1,3,5-triazine and 1,2-bis-(3-aminopropylamino)ethane,
(42) a reaction product of 7,7,9,9-tetramethyl-2-cycloundecyl-1-oxa-3,8-diaza-4-oxospiro [4,5]decane and epichlorohydrin,
(43) poly[methyl,(3-oxy-(2,2,6,6-tetramethylpiperidin-4-yl)propyl)] siloxane, CAS#182635-99-0,
(44) reaction product of maleic acid anhydride-C₁₈-C₂₂-□-olefin-copolymer with 2,2,6,6-tetramethyl-4-aminopiperidine,
(45) oligomeric condensate of 4,4′-hexamethylenebis(amino-2,2,6,6-tetramethylpiperidine) and 2,4-dichloro-6-[(2,2,6,6-tetramethylpiperidin-4-yl)butylamino]-s-triazine end-capped with 2-chloro-4,6-bis(dibutylamino)-s-triazine,
(46) oligomeric condensate of 4,4′-hexamethylenebis(amino-1,2,2,6,6-pentaamethylpiperidine) and 2,4-dichloro-6-[(1,2,2,6,6-pentaamethylpiperidin-4-yl)butylamino]-s-triazine end-capped with 2-chloro-4,6-bis(dibutylamino)-s-triazine,
(47) oligomeric condensate of 4,4′-hexamethylenebis(amino-l-propoxy-2,2,6,6-tetramethyl-piperidine) and 2,4-dichloro-6-[(1-propoxy-2,2,6,6-tetramethylpiperidin-4-yl)butylamino]-s-triazine end-capped with 2-chloro-4,6-bis(dibutylamino)-s-triazine,
(48) oligomeric condensate of 4,4′-hexamethylenebis(amino-1-acyloxy-2,2,6,6-tetramethyl-piperidine) and 2,4-dichloro-6-[(1-acyloxy-2,2,6,6-tetramethylpiperidin-4-yl)butylamino]-s-triazine end-capped with 2-chloro-4,6-bis(dibutylamino)-s-triazine,
(49) product obtained by reacting (a) with (b) where (a) is product obtained by reacting 1,2-bis(3-aminopropylamino)ethane with cyanuric chloride and (b) is (2,2,6,6-tetramethylpiperidin-4-yl)butylamine,
   or a mixture thereof.

Further exemplary HALS that may be included are the sterically hindered N—H, N-methyl, N-hydroxy and N-acyloxy analogues of any of the above mentioned compounds. For example, replacing an N—H hindered amine with an N-methyl hindered amine would be employing the N-methyl analogue in place of the N—H.

For illustrative purposes, some of the structures for the above-named HALS are shown below.

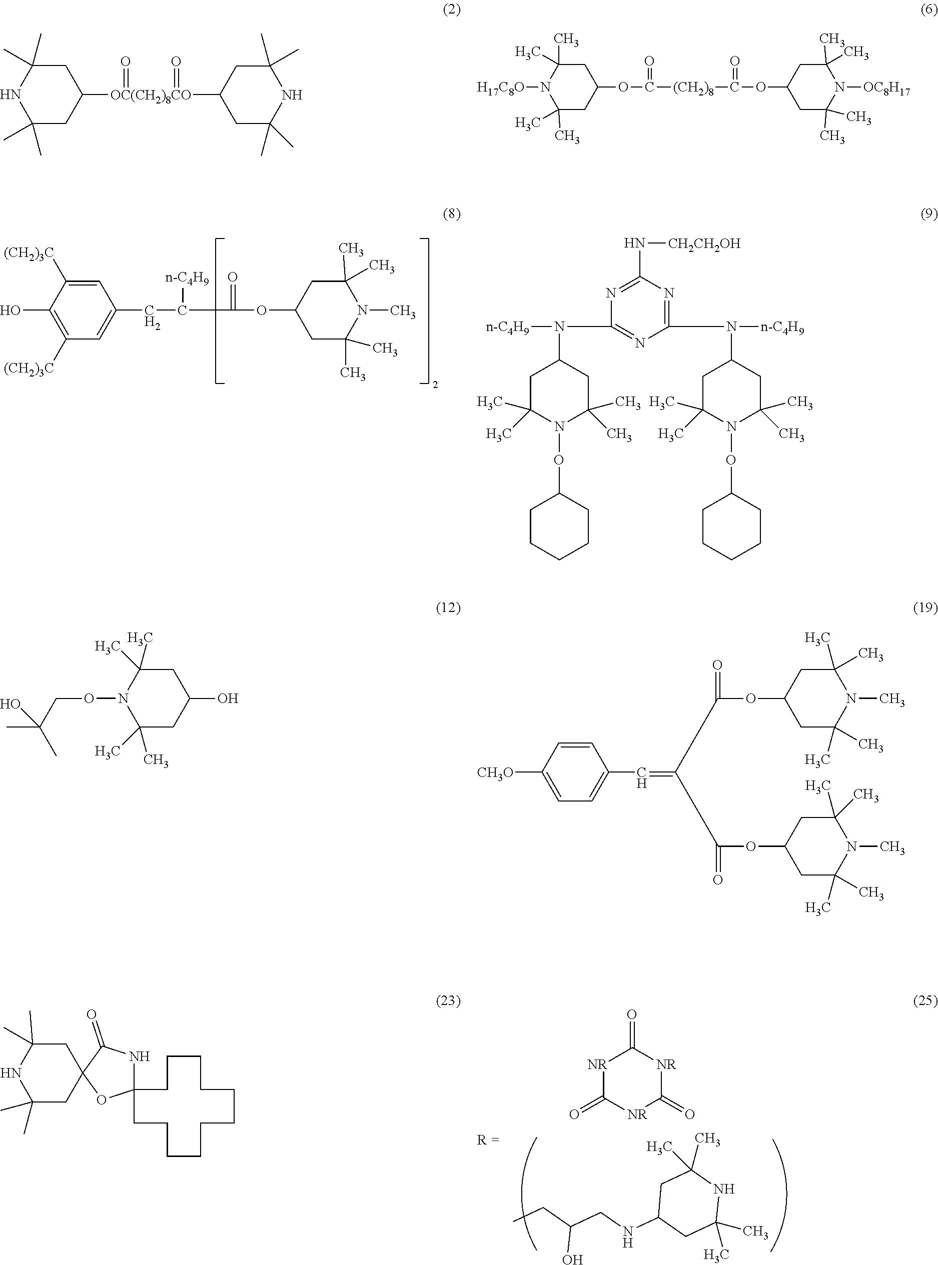

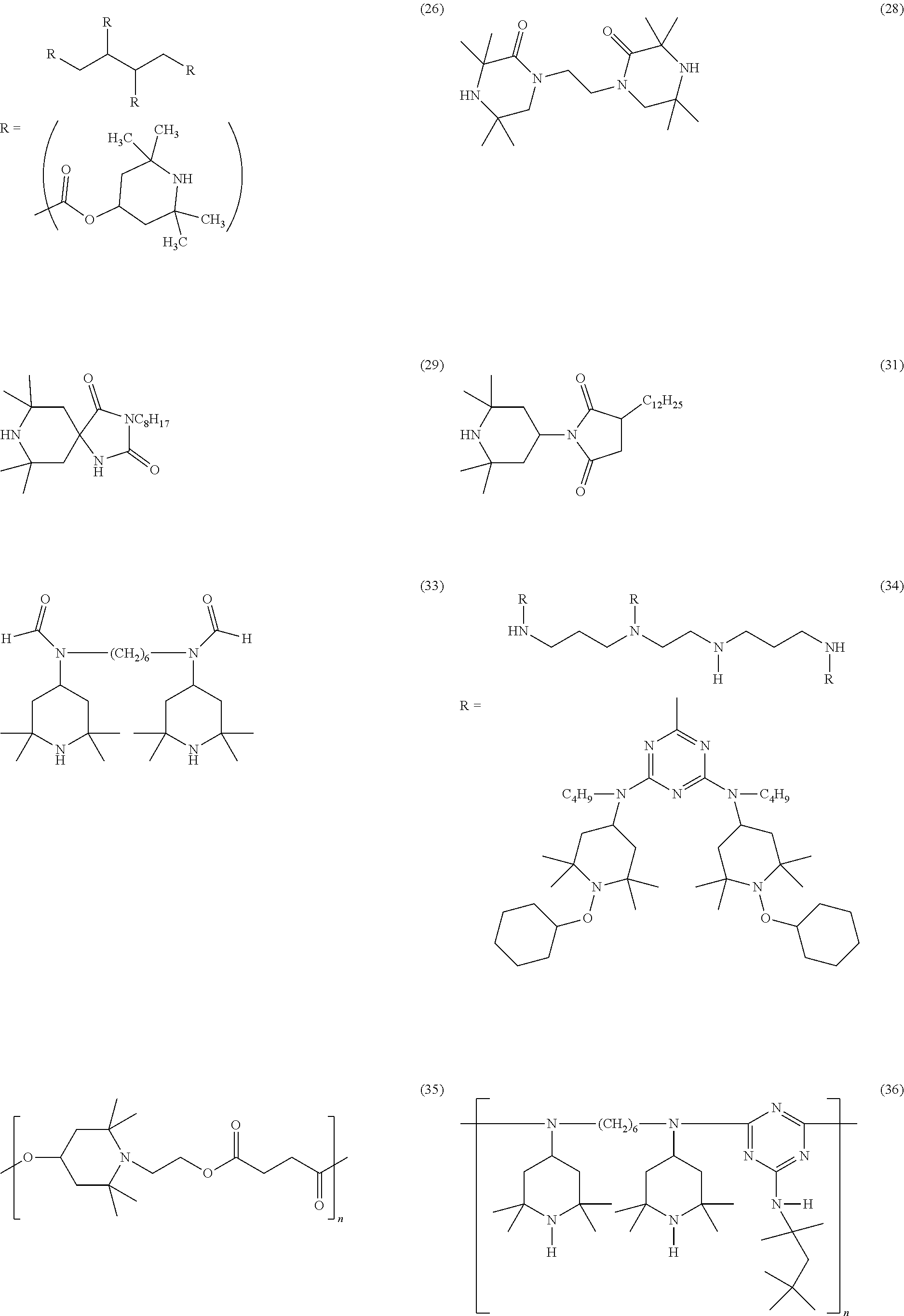

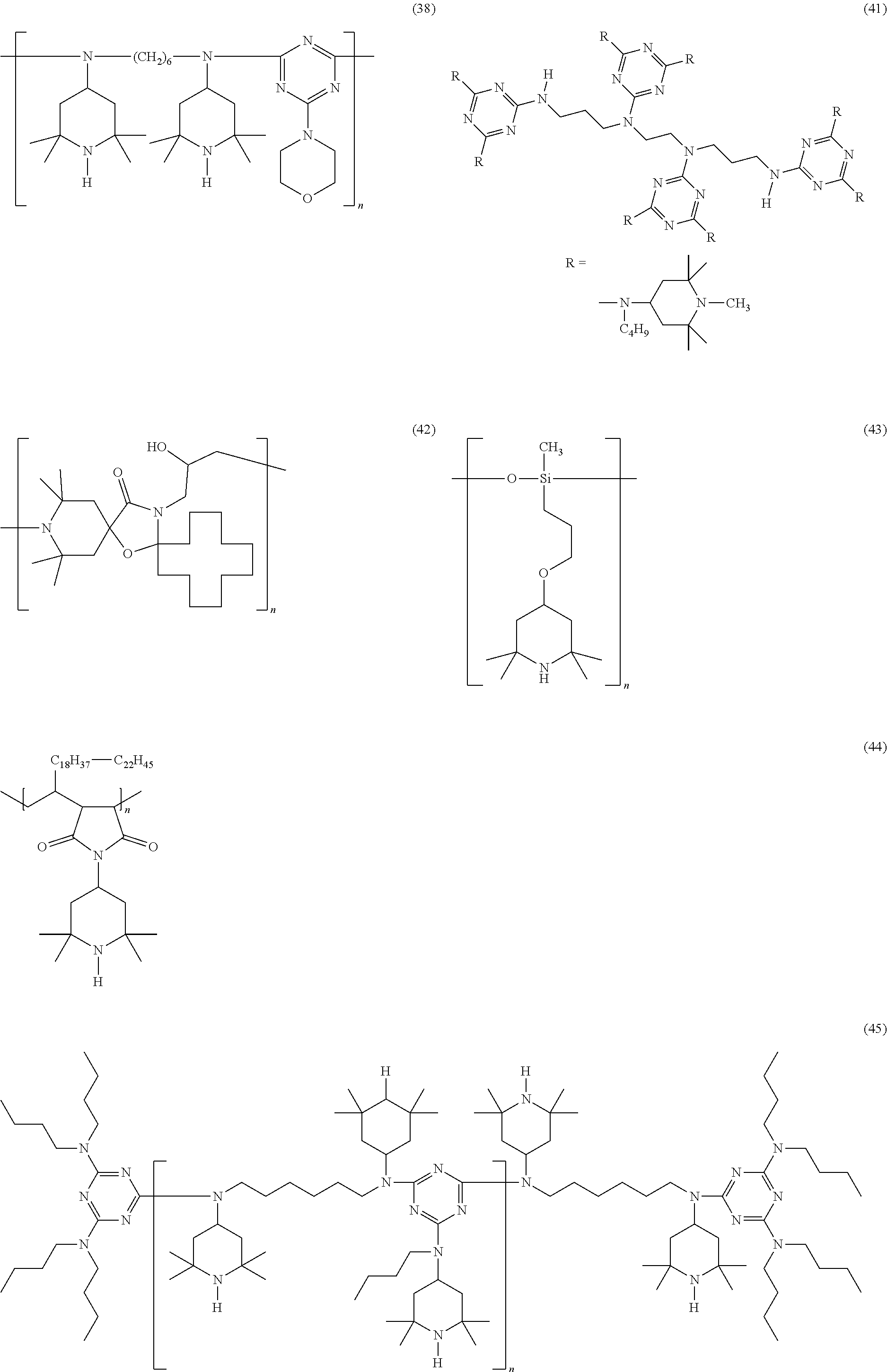

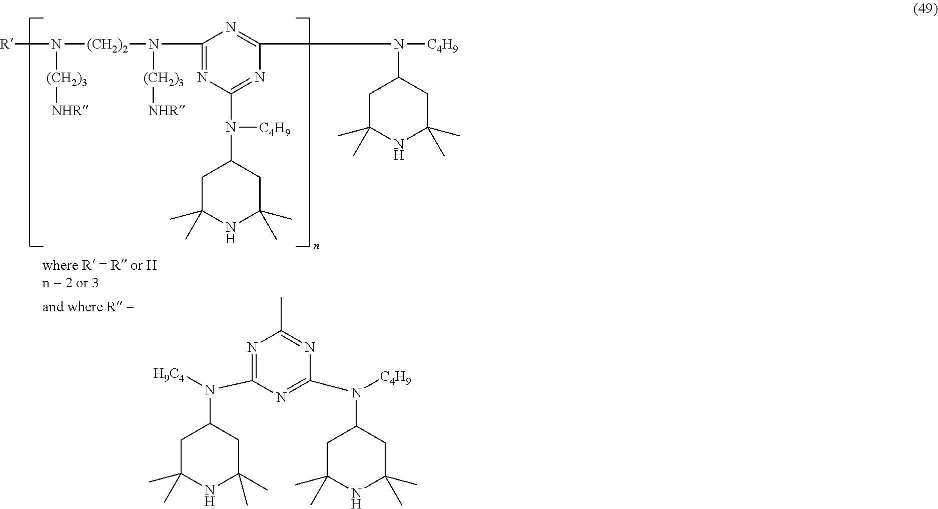

In one embodiment, the plastic article described herein and/or the stabilizer additive composition comprises at least one of the following HALS: (2) bis(2,2,6,6-tetramethylpiperidin-4-yl) sebacate, and/or (44) reaction product of maleic acid anhydride-C₁₈-C₂₂-α-olefin-copolymer with 2,2,6,6-tetramethyl-4-aminopiperidine.

Many of the HALS that may be incorporated into the plastic articles and/or stabilizer additive compositions described herein are commercial, for example TINUVIN 770, CHIMASSORB 944, CHIMASSORB 2020, CYASORB UV 3853, CYASORB UV 3529, TINUVIN NOR 371, UVINUL 4050, UVINUL 5050, etc.

Plastic articles described herein may in some embodiments comprise any of the HALS described herein at an amount ranging from about 0.01 wt % to about 0.4 wt %, from about 0.03 wt % to about 0.3 wt %, from about 0.05 wt % to about 0.2 wt %, from about 0.05 wt % to about 0.15 wt %, from about 0.07 wt % to about 0.13 wt %, or from about 0.09 wt % to about 0.11 wt %, or any wt % value or range in between, based on total weight of the plastic article. In certain embodiments, the HALS is present in the plastic article in an amount ranging from about 0.01 wt %, about 0.02 wt %, about 0.03 wt %, about 0.04 wt %, about 0.05 wt %, about 0.06 wt %, about 0.07 wt %, about 0.08 wt %, about 0.09 wt % to about 0.10 wt %, about 0.11 wt %, about 0.12 wt %, about 0.13 wt %, about 0.14 wt %, about 0.15 wt %, about 0.18 wt %, about 0.20 wt %, about 0.23 wt %, about 0.25 wt %, about 0.28 wt %, about 0.30 wt %, about 0.33 wt %, about 0.35 wt %, about 0.40 wt %, or about 0.50 wt %, based on the total weight of the plastic article.

Without being construed as limiting, it is believed that HALS enhances the weatherability of a plastic article. It was also believed that the combination of a thioester additive with HALS could have an adverse effect on the weatherability of a plastic article. It was surprisingly and unexpectedly discovered herein that it could be possible to combine HALS with a thioester additive to achieve both: enhanced weatherability and enhanced long term thermal stability.

In certain embodiments, the instant disclosure may be directed the stabilizer additive composition itself as a concentrated master batch. In a concentrated master batch of the stabilizer additive composition, the HALS may be present in an amount ranging from about 6 wt % to about 60 wt %, from about 10 wt % to about 45 wt %, from about 15 wt % to about 30 wt %, or any wt % value or range in between, based on total weight of the stabilizer additive composition. In certain embodiments, the HALS is present in the stabilizer additive composition in an amount ranging from about 6 wt % to about 8 wt %, 10 wt %, about 12 wt %, about 14 wt %, about 16 wt %, about 18 wt %, about 20 wt %, about 22 wt %, about 24 wt %, about 26 wt %, about 28 wt %, or about 30 wt % to about 35 wt %, about 38 wt %, about 40 wt %, about 42 wt %, about 44 wt %, about 46 wt %, about 48 wt %, about 50 wt %, about 52 wt %, about 54 wt %, about 56 wt %, about 58 wt %, or about 60 wt %, based on the total weight of the stabilizer additive composition. In certain embodiments, the stabilizer additive composition master batch may not comprise any HALS (i.e., 0 wt %).

In some embodiments, one or more further additives may be incorporated into the plastic articles of the invention. Further additives may be at least one of ultraviolet light absorber, acid scavengers, colorants, pigments, dyes, fillers, anti-scratch additive, or a mixture thereof.

Suitable ultraviolet (UV) light absorbers may be selected from a group consisting of oxamide, hydroxyphenylbenzotriazole, tris-aryl-s-triazine, hydroxybenzoate, 2-hydroxybenzophenone and cyanoacrylate ultraviolet light absorbers (UVAs).

Oxamide UVAs include, for example, 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide (N′-(2-ethoxyphenyl)-N-(2-ethylphenyl)oxamide), N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

Hydroxyphenylbenzotriazole UVAs are, for instance, disclosed in U.S. Pat. Nos. 3,004,896; 3,055,896; 3,072,585; 3,074,910; 3,189,615; 3,218,332; 3,230,194; 4,127,586; 4,226,763; 4,275,004; 4,278,589; 4,315,848; 4,347,180; 4,383,863; 4,675,352; 4,681,905, 4,853,471; 5,268,450; 5,278,314; 5,280,124; 5,319,091; 5,410,071; 5,436,349; 5,516,914; 5,554,760; 5,563,242; 5,574,166; 5,607,987, 5,977,219 and 6,166,218, such as 2-(2-hydroxy-5-methylphenyl)-2H-benzotriazole, 2-(3,5-di-t-butyl-2-hydroxyphenyl)-2H-benzotriazole, 2-(2-hydroxy-5-t-butylphenyl)-2H-benzotriazole, 2-(2-hydroxy-5-t-octylphenyl)-2H-benzotriazole, 5-chloro-2-(3,5-di-t-butyl-2-hydroxyphenyl)-2H-benzotriazole, 5-chloro-2-(3-t-butyl-2-hydroxy-5-methylphenyl)-2H-benzotriazole, 2-(3-sec-butyl-5-t-butyl-2-hydroxyphenyl)-2H-benzotriazole, 2-(2-hydroxy-4-octyloxyphenyl)-2H-benzotriazole, 2-(3,5-di-t-amyl-2-hydroxyphenyl)-2H-benzotriazole, 2-(3,5-bis-α-cumyl-2-hydroxyphenyl)-2H-benzotriazole, 2-(3-t-butyl-2-hydroxy-5-(2-(ω-hydroxy-octa-(ethyleneoxy)carbonyl-ethyl)-, phenyl)-2H-benzotriazole, 2-(3-dodecyl-2-hydroxy-5-methylphenyl)-2H-benzotriazole, 2-(3-t-butyl-2-hydroxy-5-(2-octyloxycarbonyl)ethylphenyl)-2H-benzotriazole, dodecylated 2-(2-hydroxy-5-methylphenyl)-2H-benzotriazole, 2-(3-t-butyl-2-hydroxy-5-(2-octyloxycarbonylethyl)phenyl)-5-chloro-2H-benzotriazole, 2-(3-tert-butyl-5-(2-(2-ethylhexyloxy)-carbonylethyl)-2-hydroxyphenyl)-5-chloro-2H-benzotriazole, 2-(3-t-butyl-2-hydroxy-5-(2-methoxycarbonylethyl)phenyl)-5-chloro-2H-benzotriazole, 2-(3-t-butyl-2-hydroxy-5-(2-methoxycarbonylethyl)phenyl)-2H-benzotriazole, 2-(3-t-butyl-5-(2-(2-ethylhexyloxy)carbonylethyl)-2-hydroxyphenyl)-2H-benzotriazole, 2-(3-t-butyl-2-hydroxy-5-(2-isooctyloxycarbonylethyl)phenyl-2H-benzotriazole, 2,2′-methylene-bis(4-t-octyl(6-2H-benzotriazol-2-yl)phenol), 2-(2-hydroxy-3-αcumyl-5-t-octylphenyl)-2H-b en-zotriazole, 2-(2-hydroxy-3-t-octyl-5-α-cumylphenyl)-2H-benzotriazole, 5-fluoro-2-(2-hydroxy-3,5-di-□-cumylphenyl)-2H-benzotriazole, 5-chloro-2-(2-hydroxy-3,5-di-α-cumylphenyl)-2H-benzotriazole, 5-chloro-2-(2-hydroxy-3-α-cumyl-5-t-octylphenyl)-2H-benzotriazole, 2-(3-t-butyl-2-hydroxy-5-(2-isooctyloxycarbonylethyl)phenyl)-5-chloro-2H-benzotriazole, 5-trifluoromethyl-2-(2-hydroxy-3-α-cumyl-5-t-octylphenyl)-2H-b enzotriazole, 5-trifluoromethyl-2-(2-hydroxy-5-t-octylphenyl)-2H-benzotriazole, 5-trifluoromethyl-2-(2-hydroxy-3,5-di-t-octyl-phenyl)-2H-benzotriazole, methyl 3-(5-trifluoromethyl-2H-benzotriazol-2-yl)-5-t-butyl-4-hydroxyhydrocinnamate, 5-butylsulfonyl-2-(2-hydroxy-3-α-cumyl-5-t-octylphenyl)-2H-benzotriazole, 5-trifluoromethyl-2-(2-hydroxy-3-αcumyl-5-t-butylphenyl)-2H-benzotriazole, 5-trifluoromethyl-2-(2-hydroxy-3,5-di-t-butylphenyl)-2H-benzotriazole, 5-trifluoromethyl-2-(2-hydroxy-3,5-di-α-cumylphenyl)-2H-benzotriazole, 5-butylsulfonyl-2-(2-hydroxy-3,5-di-t-butyl-phenyl)-2H-benzotriazole and 5-phenylsulfonyl-2-(2-hydroxy-3,5-di-t-butylphenyl)-2H-benzotriazole.

Tris-aryl-s-triazine UVAs are, for instance, those disclosed in U. S. Pat. Nos. 3,843,371; 4,619,956; 4,740,542; 5,096,489; 5,106,891; 5,298,067; 5,300,414; 5,354,794; 5,461,151; 5,476,937; 5,489,503; 5,543,518; 5,556,973; 5,597,854; 5,681,955; 5,726,309; 5,736,597; 5,942,626; 5,959,008; 5,998,116; 6,013,704; 6,060,543; 6,242,598 and 6,255,483, for example 4,6-bis-(2,4-dimethylphenyl)-2-(2-hydroxy-4-octyloxyphenyl)-s-triazine, CYASORB 1164, 4,6-bis-(2,4-dimethylphenyl)-2-(2,4-dihydroxyphenyl)-s-triazine, 2,4-bis(2,4-dihydroxyphenyl)-6-(4-chlorophenyl)-s-triazine, 2,4-bis[2-hydroxy-4-(2-hydroxy-ethoxy)phenyl]-6-(4-chlorophenyl)-s-triazine, 2,4-bis[2-hydroxy-4-(2-hydroxy-4-(2-hydroxy-ethoxy)phenyl]6-(2,4-dimethylphenyl)-s-turazine, 2,4-bis[2-hydroxy-4-(2-hydroxyethoxy)-phenyl]-6-(4-bromophenyl)-s-triazine, 2,4-bis[2-hydroxy-4-(2-acetoxyethoxy)phenyl]-6-(4-chlorophenyl)-s-triazine, 2,4-bis(2,4-dihydroxyphenyl)-6-(2,4-dimethylphenyl)-s-triazine, 2,4-bis(4-biphenylyl)-6-(2-hydroxy-4-octyloxycarbonylethylideneoxyphenyl)-s-triazine, 2-phenyl-4-[2-hydroxy-4-(3-sec-butyloxy-2-hydroxypropyloxy)phenyl]-6-[2-hydroxy-4-(3-sec-amyloxy-2-hydroxypropyloxy)phenyl]-s-triazine, 2,4-bis(2,4-dimethylphenyl)-6-[2-hydroxy-4-(3-benzyloxy-2-hydroxypropyloxy)phenyl]-s-triazine, 2,4-bis(2-hydroxy-4-n-butyloxyphenyl)-6-(2,4-di-n-butyloxyphenyl)-s-triazine, 2,4-bis(2,4-dimethylphenyl)-6-[2-hydroxy-4-(3-nonyloxy*-2-hydroxypropyloxy)-5-□-cumylphenyl]-s-triazine (*denotes a mixture of octyloxy, nonyloxy and decyloxy groups), methylenebis-{2,4-bis(2,4-dimethylphenyl)-6-[2-hydroxy-4-(3-butyloxy-2-hydroxypropoxy)phenyl]-s-triazine}, methylene bridged dimer mixture bridged in the 3:5′, 5:5′ and 3:3′ positions in a 5:4:1 ratio, 2,4,6-tris(2-hydroxy-4-isooctyloxycarbonylisopropylideneoxy-phenyl)-s-triazine, 2,4-bis(2,4-dimethylphenyl)-6-(2-hydroxy-4-hexyloxy-5-α-cumylphenyl)-s-triazine, 2-(2,4,6-trimethylphenyl)-4,6-bis[2-hydroxy-4-(3-butyloxy-2-hydroxypropyloxy)-phenyl]-s-triazine, 2,4,6-tris[2-hydroxy-4-(3-sec-butyloxy-2-hydroxypropyloxy)phenyl]-s-triazine, mixture of 4,6-bis-(2,4-dimethylphenyl)-2-(2-hydroxy-4-(3-dodecyloxy-2-hydroxypropoxy)-phenyl)-s-triazine and 4,6-bis-(2,4-dimethylphenyl)-2-(2-hydroxy-4-(3-tridecyloxy-2-hydroxypropoxy)-phenyl)-s-triazine, TINUVIN 400, 4,6-bis-(2,4-dimethyl-phenyl)-2-(2-hydroxy-4-(3-(2-ethylhexyloxy)-2-hydroxypropoxy)-phenyl)-s-triazine and 4,6-diphenyl-2-(4-hexyloxy-2-hydroxyphenyl)-s-triazine.

Hydroxybenzoate UV absorbers are, for instance, esters of substituted and unsubstituted benzoic acids, as for example 4-tert-butylphenyl salicylate, phenyl salicylate, octylphenyl salicylate, dibenzoyl resorcinol, bis(4-tert-butylbenzoyl) resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2-Hydroxybenzophenone UV absorbers are, for example, the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

Cyanoacrylate UV absorbers are for instance pentaerythritol tetrakis(2-cyano-3,3-diphenylacrylate), α-cyano-β,β-diphenylacrylic acid ethyl ester or isooctyl ester and α-cyano-β-methyl-p-methoxy-cinnamic acid methyl ester or butyl ester.

Many of the UVAs are commercial, for example TINUVIN 326, TINUVIN 234, TINUVIN 1577, TINUVIN 1600, CYASORB UV 1164, CYASORB THT, CYASORB UV 2908, CHIMASSORB 81, UVINUL 3030, etc.

Acid scavengers that may be included in the plastic articles described herein may comprise hydrotalcites and amorphous basic aluminum magnesium carbonates, such as those described in U.S. Pat. Nos. 4,427,816, 5,106,898 and 5,234,981. Hydrotalcite is also known as hycite, DHT4A, DHT4V, DHT4Z, DHT4A2 or DHT4C. Hydrotalcites are natural or synthetic and may include a coating. Natural hydrotalcite is held to possess a structure Mg₆Al₂(OH)₁₆CO_{3.4} H₂O. A typical empirical formula of a synthetic hydrotalcite is Al₂Mg_{4.350}Oh_{11.36}CO_{3(1.67)}.x H₂O. Examples of the synthetic product include Mg_{0.7}Al_{0.3}(OH)₂(CO₃)_{0.15.}0.54 H₂O, Mg_{4.5}Al₂(OH)₁₃CO₃.3.5 H₂O and Mg_{4.2}Al(OH)_{12.4}CO₃.

In some embodiments, suitable acid scavengers include metal salts of fatty acids, for example alkali or alkali earth metal salts of fatty acids. In some embodiments, acid scavengers include calcium, magnesium, zinc, sodium, potassium or aluminum salts of fatty acids. In some embodiments, acid scavengers include calcium, magnesium, zinc, sodium, potassium or aluminum stearate, behenate, ricinoleate or palmitate. In certain embodiments, acid scavengers include calcium stearate, zinc stearate, magnesium behenate, magnesium stearate, sodium ricinoleate and potassium palmitate. In other embodiments, acid scavengers include zinc oxide. In one embodiment, the acid scavenger may be calcium stearate. In some embodiments, a combination of one or more acid scavengers may be employed.

In certain embodiments, the plastic articles may comprise acid scavengers from any of about 0.02 wt %, about 0.04 wt %, about 0.06 wt %, or about 0.08 wt % to about 0.12 wt %, about 0.14 wt %, about 0.16 wt %, about 0.18 wt %, or about 0.2 wt %, or any wt % value or range in between, based on the total weight of the plastic article.

Colorants, pigments, dyes, or fillers may also be added to the plastic articles described herein.

Pigments include inorganic pigments, such as titanium dioxide in its three crystalline forms: rutile, anatase, or brookite, ultramarine blue, iron oxides, bismuth vanadates, carbon black, effect pigments including metallic pigments such as aluminum flake and pearlescent pigments such as micas, and organic pigments, for example phthalocyanines, perylenes, azo compounds, isoindolines, quinophthalones, diketopyrrolopyrroles, quinacridones, dioxazines, and indanthrones. Pigments may be included singly or in any combination in amounts typically of up to about 5% by weight, based on the total weight of the article.

Dyes are any of the colorants which dissolve completely in the plastic used or are present in molecularly dispersed form and therefore can be used to provide high-transparency, non-diffusion coloring of polymers. Other dyes are organic compounds which fluoresce in the visible portion of the electromagnetic spectrum, e.g. fluorescent dyes. Dyes may be included singly or in any combination in amounts typically of up to about 5% by weight, based on the total weight of the article.

Particulate fillers may be present in an amount from any of about 0.01 wt %, about 0.1 wt %, about 1 wt %, about 5 wt %, about 10 wt %, or about 15 wt % to about 20 wt %, about 25 wt %, about 30 wt %, about 35 wt %, about 40 wt %, about 45 wt % or about 50 wt %, based on the total weight of the plastic article. Fillers include but are not limited to titanium dioxide, silicon carbide, silica (and other oxides of silica, precipitated or not), antimony oxide, lead carbonate, zinc white, lithopone, zircon, corundum, spinel, apatite, barytes powder, barium sulfate, carbon black, dolomite, calcium carbonate, talc (e.g., fine talc), and hydrotalcite compounds of the ions Mg, Ca, or Zn with Al, Cr or Fe and CO₃ and/or HPO₄, hydrated or not; quartz powder, hydrochloric magnesium carbonate, glass fibers, clays, alumina, and other metal oxides and carbonates, metal hydroxides, chrome, phosphorous, antimony trioxide, silica, silicone, and blends thereof. These fillers may include any other fillers and porous fillers and supports known in the art.

Still further additives may be incorporated into the plastic articles described herein include, without limitations, anti-static agents (antistats), antiscratch additives (e.g., primary amide additive), slip agents, polymer processing aids, etc. (see Plastic Additives Handbook; 6^{th} Edition). Included are metal salts of fatty acids, for example, calcium, magnesium, zinc, or aluminum stearate.

Further additives may also include benzofuranone stabilizers, for example those disclosed in U.S. Pat. Nos. 4,325,863, 4,338,244, 5,175,312, 5,216,052, 5,252,643, 5,369,159, 5,356,966, 5,367,008, 5,428,177 or 5,428,162 or U.S. Patent App. Pub. No. 2012/0238677, including 3-[4-(2-acetoxyethoxy)phenyl]-5,7-di-tert-butyl-benzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butyl-benzofuran-2-one, 3-(3,5-dimethyl-4-pivaloyloxyphenyl)-5,7-di-tert-butyl-benzofuran-2-one, 3-(3,4-dimethylphenyl)-5,7-di-tert-butyl-benzofuran-2-one, 3-(2-acetyl-5-isooctylphenyl)-5-isooctylbenzofuran-2-one and 3-(2,3-dimethylphenyl)-5,7-di-tert-butyl-benzofuran-2-one.

### Performance

In certain other embodiments, the plastic articles described herein exhibit at least one of a) long term thermal stability at 150° C. (long term thermal stability), b) resistance to degradation under UV and visible light exposure (weathering), or c) resistance to discoloration upon exposure to exhaust fumes originating from other vehicles or during warehouse storage (gas fade). In certain embodiments, the plastic articles described herein exhibit two or more of a), b), and c). In certain embodiments, the plastic articles described herein exhibit all three of a), b), and c).

In certain embodiments, the plastic article described herein exhibits a yellowness index (YI) delta (ΔYI), at 168 hours, in gas fade testing performed according to AATCC 23 ranging from about 1.2 to about 1.9, from about 1.3 to about 1.8, from about 1.5 to about 1.9, from about 1.6 to about 1.8, or from about 1.4 to about 1.6, or any sub-range or single value therein.

In certain embodiments, the plastic article described herein exhibits a long term thermal stability at 150° C. evidenced by hours to failure of greater than about 350 hours, greater than about 500 hours, greater than about 550 hours, greater than about 600 hours, greater than about 650 hours, greater than about 700 hours, or greater than about 750 hours, tested in accordance with ASTM D3012. In certain embodiments, the plastic article described herein exhibits a long term thermal stability at 150° C. evidenced by hours to failure ranging from about 500 hours to about 1500 hours, from about 500 hours to about 1250 hours, from about 500 hours to about 1000 hours, from about 700 hours to about 1500 hours, from about 750 hours to about 1250 hours, from about 800 hours to about 1000 hours, tested in accordance with ASTM D3012.

In certain embodiments, the plastic material, either as extruded pellets, or as an article, exhibits a color change of less than 10 YI units after about 200 hours at 150° C., of less than 15 YI units after 400 hours at 150° C., or of less than 20 YI units after 500 hours at 150° C.

In certain embodiments, the plastic article described herein exhibits 60° gloss retention, after 2000 hours, ranging from about 40 to about 80, from about 42 to about 70, or from about 45 to about 68, tested in accordance with SAE J2412 weathering conditions. In certain embodiments, the plastic article described herein exhibits 60° gloss retention, after 2000 hours, of greater than about 40, greater than about 45, greater than about 50, greater than about 55, greater than about 60, or greater than about 65, tested in accordance with SAE J2412 weathering conditions. In certain embodiments, the 60° gloss retention may range from about 45% to about 70%, from about 40% to about 70%, from about 45% to about 68%, from about 50% to about 67%, from about 50% to about 60%, from about 52% to about 59%, or from about 54% to about 55%, tested in accordance with SAE J2412 weathering conditions. The 60° gloss retention may

$$be calculated as follows : 60 ° gloss retention = \frac{60 ° gloss after 2000 hours}{Initial 60 ° gloss} \cdot 100 \% .$$

In certain embodiments, the plastic article described herein exhibits hours to failure, as tested by Xenon WOM J2412 (to assess weatherability), of greater than about 2750 hours, greater than about 3000 hours, greater than about 3500 hours, greater than about 4000 hours, greater than about 4500 hours, or greater than about 5000 hours.

In certain embodiments, the plastic article described herein exhibits a color change (as Delta E), of about 0 to 10 units after about 800 hours or about 780 hours, of 1 to 8 after about 800 hours or about 780 hours, or of 2 to 3 after about 800 hours or about 780 hours.

### EXAMPLES

The following examples are set forth to assist in understanding the embodiments described herein and should not be construed as specifically limiting the embodiments described and claimed herein. Such variations, including the substitution of all equivalents now known or later developed, which would be within the purview of those skilled in the art, and changes in formulation or minor changes in experimental design, are to be considered to fall within the scope of the embodiments incorporated herein.

### Example 1

Eight additive formulations were added to a base polymer composition that is conventionally used for a colored talc-filled thermoplastic olefin (TPO) for automotive interior applications.

A conventional base polymer composition may have a formulation as depicted in table 1 below.

TABLE 1
Conventional Base Polymer Composition

| Function | Parts by Weight | |
|---|---|---|
| Polymer (e.g., polypropylene homopolymer or | 55-65 | (e.g., 61) |
| copolymer) | | |
| Elastomer (e.g., ethylene-octene copolymer) | 15-25 | (e.g., 21) |
| Fine talc | 10-25 | (e.g., 16) |
| Acid Scavenger (e.g., calcium stearate) | 0.05-0.15 | (e.g., 0.1) |
| Anti-scratch/Slip Agent (e.g., primary amide) | 0.3-0.6 | (e.g., 0.4) |
| Colorant (added as masterbatch) | 1-3 | (e.g., 1) |
| Phenolic Antioxidant | 0.05-0.1 | (e.g., 0.08) |
| Phosphite Stabilizer | 0.05-0.15 | (e.g., 0.12) |

To 100 g of the above conventional base polymer composition, seven different additive combinations (formulations 2 through 7), as summarized in table 2 below, were added. The first control formulation in Table 2 below included the above conventional base polymer composition without any additive combination.

Thioester 1 was dioctadecyl 3,3′-thiodipropionate (CAS No. 693-36-7) with the following chemical structure:

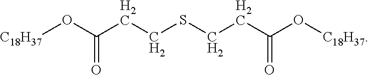

Thioester 2 was 2,2-bis[[3-(dodecylthio)-1-oxopropoxy]methyl]propane-1,3-diyl bis[3-(dodecylthio)propionate] (CAS No. 29598-76-3) with the following chemical structure:

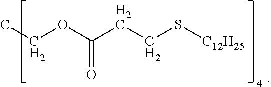

HALS 1 was Bis(2,2,6,6,-tetramethyl-4-piperidyl)sebaceate (CAS No. 52829-07-9) with the following chemical structure:

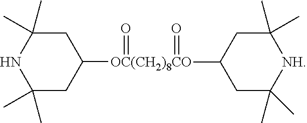

TABLE 2
Additive Combinations

| Formulation | Thioester 1 | Thioester 2 | HALS 1 |
|---|---|---|---|
| 1 (control) | | | |
| 2 | | 0.1 | |
| 3 | 0.1 | | |
| 4 | | | 0.1 |
| 5 | | 0.1 | 0.14 |
| 6 | 0.1 | | 0.1 |
| 7 | | 0.23 | 0.1 |
| 8 | 0.2 | | 0.1 |

All of the above formulations were subjected to the following tests:
1) Oxidative degradation using method ASTM D3012 to assess long term thermal stability, and
2) Xenon weatherometer accelerated testing using method SAE J2412 to assess weatherability.

Performance was measured via Yellowness Index (YI) and/or hours to failure and/or 60° gloss retention.

The long term thermal stability and weathering results are summarized in Table 3 below:

TABLE 3
Long Term Thermal Stability and Weatherability Results

| | | | | | | Thermal |
|---|---|---|---|---|---|---|
| | | | | | | Aging |
| | | | | | | 150° C. |
| | | | | Xenon | | (long |
| | | | | WOM J2412 | | term |
| | | | | (weatherability) | | thermal |
| | Thio- | Thio- | | 60° | Hrs. | stability) |
| Formu- | ester | ester | HALS | Gloss @ | to | Hrs. |
| lation | 1 | 2 | 1 | 2000 Hrs | Fail | to Fail |
| 1 | — | — | — | 35 | 2500 | 213 |
| 2 | — | 0.1 | — | 0 | 750 | 550 |
| 3 | 0.1 | — | — | 0 | 1250 | 550 |
| 4 | — | — | 0.1 | 68 | >5000 | 450 |
| 5 | — | 0.1 | 0.14 | 49 | 4500 | 550 |
| 6 | 0.1 | — | 0.1 | 65 | >5000 | 550 |
| 7 | — | 0.23 | 0.1 | 0 | 1250 | 750 |
| 8 | 0.2 | — | 0.1 | 51 | >5000 | 550 |

It can be seen in Table 3 that formulations 2 and 3, containing thioester (whether Thioester 1 or Thioester 2), exhibit a better performance in thermal aging (550 hours to fail) than formulation 1, without thioester (213 hours to fail). Likewise, formulations 5, 6, 7, and 8, containing thioester (whether Thioester 1 or Thioester 2), exhibit a better performance in thermal aging (550-750 hours) than formulation 5, with HALS1 and without a thioester (450 hours).

Thus it was concluded that thioester is beneficial to longterm thermal aging performance.

On the other hand, formulation 2 and 3, containing thioester (whether Thioester 1 or Thioester 2), exhibited a seemingly worse performance in artificial weathering (60° Gloss @2000 Hrs of 0) than formulation 1, containing no thioester (60° Gloss @2000 Hrs of 35). The skilled artisan might have concluded, based on formulations 1-3, that the use of thioester in formulations requiring weathering durability is not possible and/or that the achievement of both weathering and longterm thermal performance at 150 C is not possible.

However, surprisingly, formulations 5,6, and 8, containing moderate levels of thioester (whether thioester 1 or thioester 2) and HALS 1 exhibited good performance in both weathering and thermal aging, as compared to formulation 1.

On the other hand, formulation 7, containing a higher level of thioester 2, exhibited excellent thermal aging performance, but poor weathering performance, even in the presence of HALS 1.

It was concluded that, in order to achieve both weathering and thermal durability, a particular balance of the levels of thioester and HALS is required.

### Example 2

Twelve additive formulations were added to a base polymer composition that is conventionally used for a talc-filled thermoplastic olefin (TPO) used for automotive interior applications. The base polymer composition was unpigmented (neutral) polymer.

The conventional base polymer composition tested in Example 2 had a formulation as depicted in table 4 below.

TABLE 4
Conventional Base Polymer Composition of Example 2

| Function | Parts by Weight | |
|---|---|---|
| Polymer (e.g., polypropylene homopolymer or | 55-65 | (e.g., 61) |
| copolymer) | | |
| Elastomer (e.g., ethylene-octene copolymer) | 15-25 | (e.g., 21) |
| Fine talc | 10-25 | (e.g., 16) |
| Acid Scavenger (e.g., calcium stearate) | 0.05-0.15 | (e.g., 0.1) |
| Anti-scratch/Slip Agent (e.g., primary amide) | 0.3-0.6 | (e.g., 0.25) |

To 100 g of the conventional base polymer composition from table 4, twelve different additive combinations, as summarized in table 5 below, were added. Thioester 1, thioester 2, and HALS 1 were the same as in Example 1.

The phenolic antioxidant (AO1) was Tris(3,5-di-tert-butyl-4-hydroxybenzyl) isocyanurate (CAS No. 27676-62-6) with the following chemical structure:

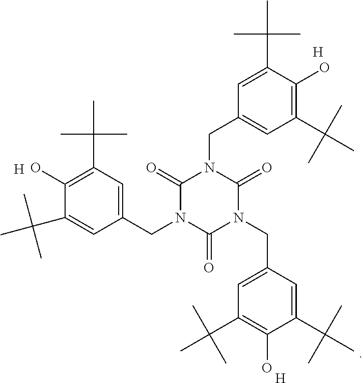

The phenolic antioxidant (AO2) was pentaerythritol tetrakis [3-(3,5-di-tert-butyl-4-hydroxyphenyl) propionate] (CAS No. 6683-19-8) with the following chemical structure:

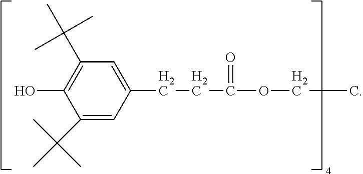

The phosphite stabilizer (Phosphite 1) was tris(2,4-di-tert-butylphenyl) phosphite

(CAS No. 31570-04-4) with the following chemical structure:

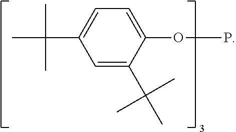

TABLE 5
Additive Combinations (wt %)

| Formu- | | | Phosphite | Thioester | Thioester | HALS |
|---|---|---|---|---|---|---|
| lation | AO1 | AO2 | 1 | 1 | 2 | 1 |
| 1 | 0.08 | — | 0.12 | — | — | — |
| 2 | 0.08 | — | 0.12 | — | 0.1 | — |
| 3 | 0.08 | — | 0.12 | 0.1 | — | — |
| 4 | 0.08 | — | 0.12 | — | 0.1 | 0.1 |
| 5 | 0.08 | — | 0.12 | 0.1 | — | 0.1 |
| 6 | 0.08 | — | 0.12 | — | 0.2 | 0.1 |
| 7 | 0.08 | — | 0.12 | 0.2 | — | 0.1 |
| 8 | 0.08 | — | 0.12 | — | — | 0.1 |
| 9 | 0.08 | — | 0.12 | — | 0.2 | — |
| 10 | 0.08 | — | 0.12 | 0.2 | — | — |
| 11 | 0.12 | — | 0.18 | — | — | 0.1 |
| 12 | — | 0.08 | 0.12 | — | 0.1 | 0.1 |

All of the above formulations were subjected to the following tests:
1) AATCC 23—colorfastness to burnt gas fumes to assess gas fade,
2) Oxidative degradation using method ASTM D3012 to assess long term thermal stability, and
3) Xenon weatherometer accelerated testing using method SAE J2412 to assess weatherability.

Performance was measured via Yellowness Index (YI) and/or Delta E color change and/or hours to failure.

The results are depicted in Table 6 below:

TABLE 6
Gas Fade, Long Term Thermal Stability, and Weatherability
of Formulations 1-12 from Table 5

| | Xenon | Thermal | | | | |
|---|---|---|---|---|---|---|
| | WOM | Aging 1500 | | | | |
| | J2412 | C (long term | | | | |
| | (weather- | thermal | Gas Fade | | | |
| | ability) | stability) | ΔYI of | Ini- | YI at | ΔYI |
| | Delta E | Hours to Fail | pellets | tial | t = | after |
| Formu- | after | (Delta | after | YI at | 168 | 168 |
| lation | 780 hrs | E >4) | 400 hrs | t = 0 | hrs | hours |
| 1 | 13.5 | 277 | 21.9 | 21.2 | 23.2 | 2.0 |
| 2 | 12.4 | 277 | 9.0 | 18.7 | 20.0 | 1.3 |
| 3 | 12.5 | 277 | 12.4 | 20.3 | 22.0 | 1.7 |
| 4 | 2.5 | 850 | 7.3 | 18.2 | 20.0 | 1.8 |
| 5 | 2.3 | 850 | 11.4 | 20.0 | 21.8 | 1.8 |
| 6 | 8.8 | 640 | 7.1 | 17.7 | 19.3 | 1.6 |
| 7 | 7.4 | 780 | 10 | 19.6 | 21.5 | 1.9 |
| 8 | 2.1 | >950 | 21.4 | 20.7 | 22.2 | 1.5 |
| 9 | 10.3 | 500 | 8.2 | 17.6 | 19.0 | 1.4 |
| 10 | 12.7 | 500 | 11.7 | 19.6 | 21.1 | 1.5 |
| 11 | 2.5 | >950 | 21.5 | 21.1 | 22.7 | 1.6 |
| 12 | 5.5 | 780 | 12.4 | 17.7 | 20.7 | 3.0 |

### Weatherability

The results in Table 6 showed that formulations 8 and 11, stabilized with the Hindered amine light stabilizer HALS 1, and containing no thioester thermal stabilizer, exhibited excellent weatherability performance (highest hours to failure of >950 and low delta E after 780 hours). Formulations 4 and 5, containing HALS 1 and a moderate level of thioester stabilizer, also exhibit excellent weatherability performance, retaining low color change after 780 hours exposure and a great number of hours to failure of 850 hours.

In contrast, formulations 6 and 7, also containing HALS 1, but a higher level (0.2 wt %) of thioester, did not perform as well on xenon exposure, thus exhibiting an unacceptable detrimental effect of thioester on weathering performance, as evidenced by the increased delta E values.

The above results also showed significantly poorer performance of formulation 12, containing AO2, versus formulation 4, containing AO1, in combination with thioester 2 and HALS 1.

The above results show that it is possible to include thioesters in combination with HALS and certain phenolic antioxidants and still achieve excellent weathering results, as evidenced in formulations 4 and 5.

### Oxidative Thermal Stability (Long Term Thermal Stability):

The data in table 6 above showed the beneficial effect of both thioester 1 and thioester 2 on thermal oxidative stability. Formulations 2,3,4,5,6,7,9,10, and 12, which contained thioester, exhibited a lower degree of color change (delta YI) than formulations 1,8, and 11, which did not contain thioester.

Higher levels of phenolic antioxidant, as in formulation 11, did not compensate for the omission of the thioester.

Furthermore, formulations 2,4,6,9, and 12, containing thioester 2 consistently exhibited lower color change, or better performance, than formulations 3,5,7, and 10, which contained thioester 1 but otherwise stabilized identically.

Furthermore, the formulations 9, 10, 6, and 7, stabilized with the higher level of thioesters 1 and 2 exhibited only slightly better performance than their counterparts formulations 2,3, 4, and 5, stabilized with lower (moderate) levels of thioesters 1 and 2.

These results indicated that it is possible to achieve both weathering performance and oxidative thermal stability using the combination of components and levels of components as exemplified in formulations 4 and 5.

### Gas Fade:

Gas fade results are most often expressed in terms of delta, or change in, YI. Typically, a delta YI of 2 units or less at 168 hours is considered a passing result. In this case, most of the formulations, with the exception of formulation 12, which contains AO2 instead of AO1, passed this requirement. The differences in delta YI among the other formulations was only slight.

However, the differences in actual YI value both before (at time zero) and after 168 hours gas fade exposure exhibit a consistent trend. Formulations 2,3,4,5,6,7,9, and 10, containing thioester, exhibited a lower initial YI and final YI than formulations 1, 8, and 11, containing no thioester. Furthermore, formulations 2, 4, 6, and 9, containing thioester 2, all exhibited slightly lower initial and final (168 hr) YI than formulations 3, 5, 7, and 10, containing thioester 1.

In view of the above, all of the formulations containing AO1 were acceptable for gas fade requirements, but those containing thioester, and especially thioester 2, were more desirable for both initial and final appearance, as it pertains to gas fade.

In summary, it is possible to achieve weatherability, long term oxidative stability, and gas fade requirements in the same formulation with a certain combination of phenolic antioxidant, thioester stabilizer, and Hindered amine light stabilizer, combined in certain ratios. Most surprising is the ability to achieve weatherability of a formulation that contains thioesters at a level sufficiently high to also impart good longterm oxidative stability.

The use of the terms “a,” “an,” “the,” and similar referents in the context of describing the materials and methods discussed herein (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the materials and methods and does not pose a limitation on the scope unless otherwise claimed. No language in the specification should be construed as indicating any non-claimed element as essential to the practice of the disclosed materials and methods.

Reference throughout this specification to “one embodiment,” “certain embodiments,” “some embodiments,” “one or more embodiments” or “an embodiment” means that a particular feature, structure, material, or characteristic described in connection with the embodiment is included in at least one embodiment of the present disclosure. Thus, the appearances of the phrases such as “in one or more embodiments,” “in certain embodiments,” “in some embodiments,” “in one embodiment,” or “in an embodiment” in various places throughout this specification are not necessarily referring to the same embodiment of the present disclosure. Furthermore, the particular features, structures, materials, or characteristics may be combined in any suitable manner in one or more implementations.

Although the embodiments disclosed herein have been described with reference to particular embodiments, it is to be understood that these embodiments are merely illustrative of the principles and applications of the present disclosure. It will be apparent to those skilled in the art that various modifications and variations can be made to the method and apparatus of the present disclosure without departing from the spirit and scope of the disclosure. Thus, it is intended that the present disclosure include modifications and variations that are within the scope of the appended claims and their equivalents, and the above-described embodiments are presented for purposes of illustration and not of limitation.

In addition, the term “or” is intended to mean an inclusive “or” rather than an exclusive “or.” When the term “about” or “approximately” is used herein, this is intended to mean that the nominal value presented is precise within ±10%.

U.S. patents, U.S. patent applications and published U.S. patent applications discussed herein are hereby incorporated by reference.

What is claimed is:

1. A plastic article comprising a thermoplastic olefin substrate and a stabilizer additive composition incorporated in the thermoplastic olefin substrate, the stabilizer additive composition comprising:
i) a thioester additive;
ii) a phenolic antioxidant; and
iii) an organophosphorus stabilizer,
wherein the plastic article is at least one of solid or an automotive component.

2. (canceled)

3. The plastic article of claim 1, wherein
the thioester additive has the following chemical structure: 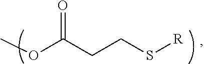
wherein R is a C₆-C₁₈ hydrocarbyl group.

4. The plastic article of claim 1, wherein the thioester additive has the following chemical structure:

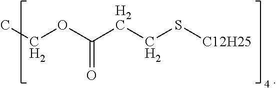

5. The plastic article of claim 1, wherein the thioester additive is present at an amount ranging from about 0.01 wt % to about 0.5 wt %, from about 0.05 wt % to about 0.3 wt %, or from about 0.08 wt % to about 0.15 wt %, by weight, based on the total weight of the plastic article.

6. The plastic article of claim 1, wherein the phenolic antioxidant comprises at least one of tris(3,5-di-tert-butyl-4-hydroxybenzyl) isocyanurate, 1,3,5-tris-(3,5-di-tert-butyl-4-hydroxybenzyl)-2,4,6-trimethylbenzene, the calcium salt of the monoethyl ester of 3,5-di-tert-butyl-4-hydroxybenzylphosphonic acid, pentaerythritol tetraki s [3-(3,5-di-tert-butyl-4-hydroxyphenyl) propionate], octadecyl 3-(3,5-di-tert-butyl-4-hydroxyphenyl) propionate, tetrakis [3-(3,5-di-tert-butyl-4-hydroxyphenyl) propionate], or a mixture thereof.

7. The plastic article of claim 1, wherein the phenolic antioxidant comprises tris(3,5-di-tert-butyl-4-hydroxybenzyl) isocyanurate and has the following chemical structure: 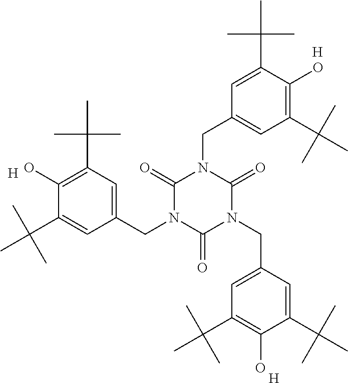
or pentaerythritol tetrakis [3-(3,5-di-tert-butyl-4-hydroxyphenyl) propionate] and had the following chemical structure:

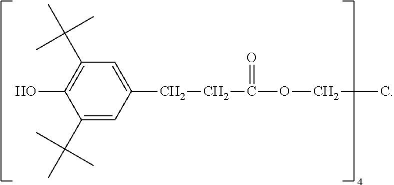

8. The plastic article of claim 1, wherein the phenolic antioxidant is present at an amount ranging from about 0.01 wt % to about 0.3 wt %, from about 0.03 wt % to about 0.2 wt %, or from about 0.05 wt % to about 0.1 wt %, by weight, based on the total weight of the plastic article.

9. The plastic article of claim 1, wherein the organophosphorus stabilizer comprises at least one of triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di-tert-butylphenyl) phosphite, bis(2,4-di-α-cumylphenyl) pentaerythrtitol diphosphite, diisodecyl pentaerythritol diphosphite, bis(2,4-di-tert-butylphenyl) pentaerythritol diphosphite (D), bis(2,6-di-tert-butyl-4-methylphenyl) pentaerythritol diphosphite (E), bisisodecyloxy-pentaerythritol diphosphite, bis(2,4-di-tert-butyl-6-methylphenyl) pentaerythritol diphosphite, bis(2,4,6-tri-tert-butylphenyl) pentaerythritol diphosphite, tristearyl sorbitol triphosphite, tetrakis (2,4-di-tert-butylphenyl) 4,4′-biphenylene-diphosphonite (H), 6-isooctyloxy-2,4,8,10-tetra-tert-butyl-dibenzo[d,f][1,3,2]di oxaphosphepin (C), 6-fluoro-2,4, 8,10-tetra-tert-butyl-12-methyl -dibenzo[d,g][1,3,2] dioxaphosphocin (A), bis(2,4-di-tert-butyl-6-methylphenyl) methyl phosphite, bis(2,4-di-tert-butyl-6-methylphenyl) ethyl phosphite (G), 2,2′,2″-nitrilo[triethyltri s(3,3′5,5′-tetra-tert-butyl-1,1′-biphenyl-2,2′diyl) phosphite] (B), bis(2,4-di-t-butylphenyl) octylphosphite, poly(4,4′-{2,2′-dimethyl-5, 5′-di-t-butylphenyl sulfide-}octylphosphite), poly(4,4′{-isopropylidenediphenol } -octylphosphite), poly(4,4′-{isopropylidenebis[2,6-dibromophenol]} -octylphosphite), poly(4,4′-{2,2′-dimethyl-5,5′-di-t-butylphenyl sulfide}-pentaerythrityl diphosphite), 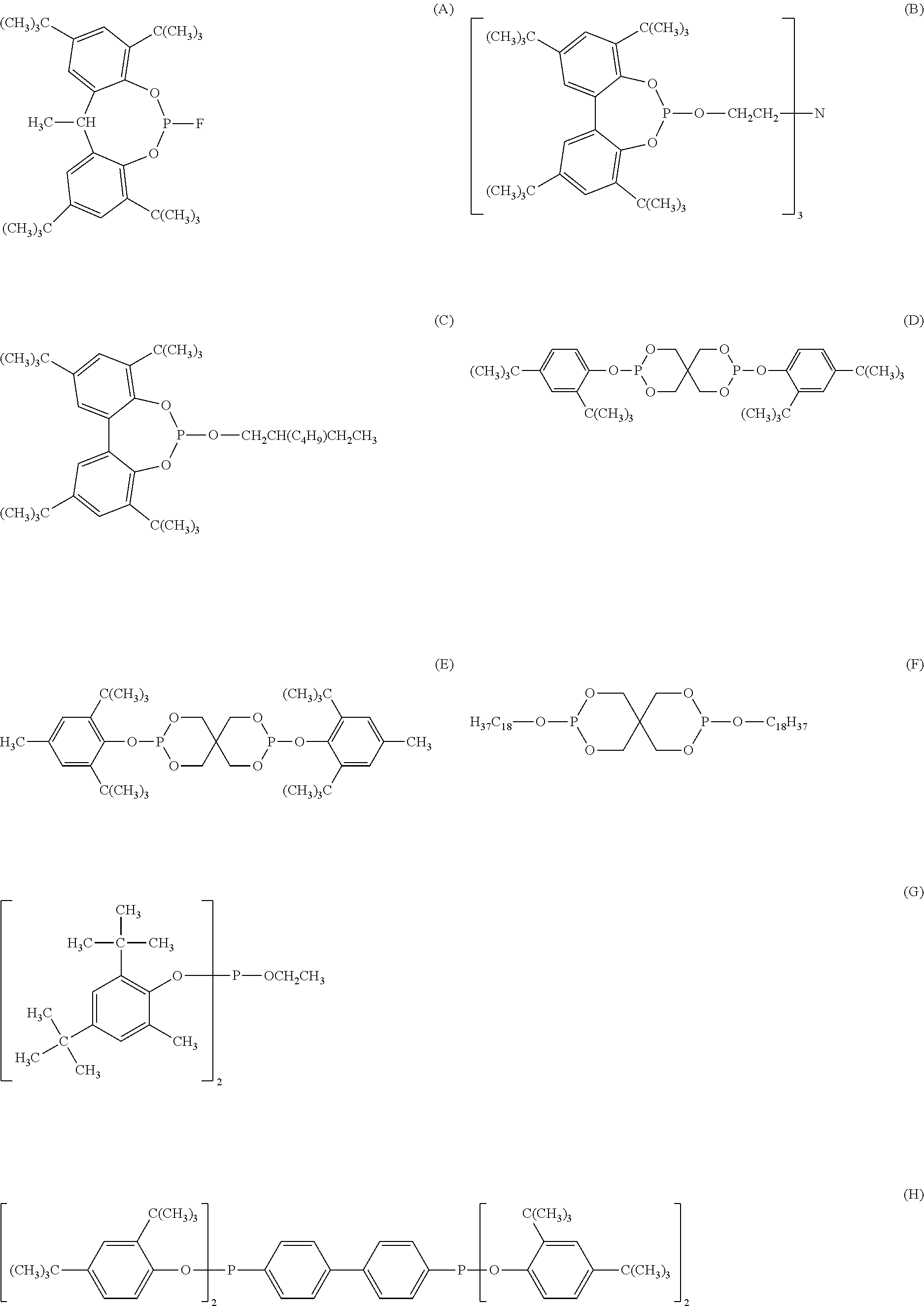 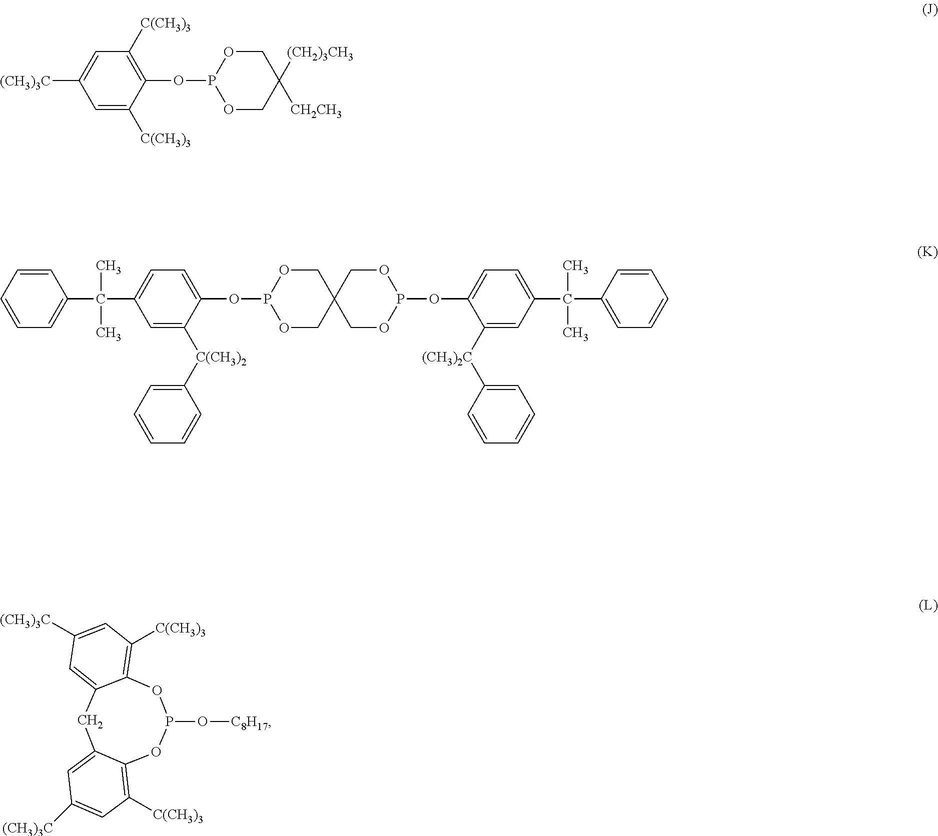
or a mixture thereof.

10. The plastic article of claim 1, wherein the organophosphorus stabilizer comprises a phosphite stabilizer that is tris(2,4-di-tert-butylphenyl) phosphite and has the following chemical structure:

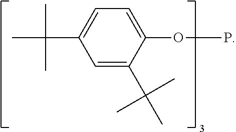

11. The plastic article of claim 1, wherein the organophosphorus stabilizer is present at an amount ranging from about 0.02 wt % to about 0.4 wt %, from about 0.03 wt % to about 0.3 wt %, or from about 0.05 wt % to about 0.2 wt %, by weight, based on the total weight of the plastic article.

12. (canceled)

13. The plastic article of claim 12, wherein the stabilizer additive composition further comprises a hindered amine light stabilizer (HALS) comprising at least one of
(1) 1-cyclohexyloxy-2,2,6,6-tetramethyl-4-octadecylaminopiperi dine,
(2) bis(2,2,6,6-tetramethylpiperidin-4-yl) sebacate,
(3) bis(1-acetoxy-2,2,6,6-tetramethylpiperidin-4-yl) sebacate,
(4) bis(1,2,2,6,6-pentamethylpiperidin-4-yl) sebacate,
(5) bis(1-cyclohexyloxy-2,2,6,6-tetramethylpiperidin-4-yl) sebacate,
(6) bis(1-octyloxy-2,2,6,6-tetramethylpiperidin-4-yl) sebacate;
(7) bis(1-acyl-2,2,6,6-tetramethylpiperidin-4-yl) sebacate,
(8) bis(1,2,2,6,6-pentamethyl-4-piperidyl) n-butyl-3,5-di-tert-butyl-4-hydroxybenzylmalonate
(9) 2,4-bis[(1-cyclohexyloxy-2,2,6,6-tetramethylpiperidin-4-yl)butylamino]-6-(2-hydroxyethyl amino-s-triazine,
(10) bis(1-cyclohexyloxy-2,2,6,6-tetramethylpiperidin-4-yl) adipate,
(11) 2,4-bis[(1-cyclohexyloxy-2,2,6,6-piperidin-4-yl)butylamino]-6-chloro-s-triazine,
(12) 1-(2-hydroxy-2-methylpropoxy)-4-hydroxy-2,2,6,6-tetramethylpiperidine,
(13) 1-(2-hydroxy-2-methylpropoxy)-4-oxo-2,2,6,6-tetramethylpiperidine,
(14) 1-(2-hydroxy-2-methylpropoxy)-4-octadecanoyloxy-2,2,6,6-tetramethylpiperidine,
(15) bis(1-(2-hydroxy-2-methylpropoxy)-2,2,6,6-tetramethylpiperidin-4-yl) sebacate,
(16) bis(1-(2-hydroxy-2-methylpropoxy)-2,2,6,6-tetramethylpiperidin-4-yl) adipate,
(17) 2,4-bis{N-[1-(2-hydroxy-2-methylpropoxy)-2,2,6,6-tetramethylpiperidin-4-yl]-N-butyl-amino}-6-(2-hydroxyethylamino)-s-triazine,
(18) 4-benzoyl-2,2,6,6-tetramethylpiperidine,
(19) di-(1,2,2,6,6-pentamethylpiperidin-4-yl) p-methoxybenzylidenemalonate,
(20) 2,2,6,6-tetramethylpiperidin-4-yl octadecanoate,
(21) bis(1-octyloxy-2,2,6,6-tetramethylpiperidyl) succinate,
(22) 1,2,2,6,6-pentamethyl-4-aminopiperidine,
(23) 2-undecyl-7,7,9,9-tetramethyl-1-oxa-3,8-diaza-4-oxo-spiro[4,5]decane,
(24) tris(2,2,6,6-tetramethyl-4-piperidyl) nitrilotriacetate,
(25) tris(2-hydroxy-3-(amino-(2,2,6,6-tetramethylpiperidin-4-yl)propyl) nitrilotriacetate,
(26) tetrakis(2,2,6,6-tetramethyl-4-piperidyl)-1,2,3,4-butane-tetracarboxylate,
(27) tetrakis(1,2,2,6,6-pentamethyl-4-piperidyl)-1,2,3,4-butane-tetracarboxylate,
(28) 1,1′-(1,2-ethanediyl)-bis(3,3,5,5-tetramethylpiperazinone),
(29) 3-n-octyl-7,7,9,9-tetramethyl-1,3,8-triazaspiro[4.5]decan-2,4-dione,
(30) 8-acetyl-3-dodecyl-7,7,9,9-tetramethyl-1,3,8-triazaspiro[4.5]decane-2,4-dione,
(31) 3-dodecyl-1-2,2,6, 6-tetramethyl-4-piperidyl)pyrrolidin-2,5-dione,
(32) 3-dodecyl-1-(1,2,2,6,6-pentamethyl-4-piperidyl)pyrrolidine-2,5-dione,
(33) N,N′-bi s-formyl-N,N′-bis(2,2,6,6-tetramethyl-4-piperidyl)hexamethylenediamine,
(33a) bis(1-undecanyloxy-2,2,6,6-tetramethylpiperidin-4-yl)carbonate,
(34) reaction product of 2,4-bis[(1-cyclohexyloxy-2,2,6,6-piperidin-4-yl)butylamino]-6 chloro-s-triazine with N,N′-bis(3-aminopropyl)ethylenediamine),
(35) condensate of 1-(2-hydroxyethyl)-2,2,6,6-tetramethyl-4-hydroxypiperidine and succinic acid,
(36) condensate of N,N′-bis(2,2,6,6-tetramethyl-4-piperidyl)-hexamethylenediamine and 4-tert-octylamino-2,6-dichloro-1,3,5-triazine,
(37) condensate of N,N′-bis(2,2,6,6-tetramethyl-4-piperidyl)-hexamethylenediamine and 4-cyclohexylamino-2,6-dichloro-1,3,5-triazine,
(38) condensate of N,N′-bis-(2,2,6,6-tetramethyl-4-piperidyl)hexamethylenediamine and 4-morpholino-2,6-dichloro-1,3,5-triazine,
(39) condensate of N,N′-bis-(1,2,2,6,6-pentamethyl-4-piperidyl)hexamethylenediamine and 4-morpholino-2,6-dichloro-1,3,5-triazine,
(40) condensate of 2-chloro-4,6-bis(4-n-butylamino-2,2,6,6-tetramethylpiperidyl)-1,3,5-triazine and 1,2-bi s(3-aminopropylamino)ethane,
(41) condensate of 2-chloro-4,6-di-(4-n-butylamino-1,2,2,6,6-pentamethylpiperidyl)-1,3,5-triazine and 1,2-bis-(3-aminopropylamino)ethane,
(42) a reaction product of 7,7,9,9-tetramethyl-2-cycloundecyl-1-oxa-3,8-diaza-4-oxospiro [4,5]decane and epichlorohydrin,
(43) poly[methyl,(3-oxy-(2,2,6,6-tetramethylpiperidin-4-yl)propyl)] siloxane, CAS#182635-99-0,
(44) reaction product of maleic acid anhydride-C₁₈-C₂₂-□-olefin-copolymer with 2,2,6,6-tetramethyl-4-aminopiperidine,
(45) oligomeric condensate of 4,4′-hexamethylenebis(amino-2,2,6,6-tetramethylpiperidine) and 2,4-dichloro-6-[(2,2,6,6-tetramethylpiperidin-4-yl)butylamino]-s-triazine end-capped with 2-chloro-4,6-bi s(dibutylamino)-s-triazine,
(46) oligomeric condensate of 4,4′-hexamethylenebis(amino-1,2,2,6,6-pentaamethylpiperidine) and 2,4-dichloro-6-[(1,2,2,6,6-pentaamethylpiperidin-4-yl)butylamino]-s-triazine end-capped with 2-chloro-4,6-bis(dibutyl amino)-s-triazine,
(47) oligomeric condensate of 4,4′-hexamethylenebis(amino-l-propoxy-2,2,6,6-tetramethyl piperidine) and 2,4-dichloro-6-[(1-propoxy-2,2,6,6-tetramethylpiperidin-4-yl)butylamino]-s-triazine end-capped with 2-chloro-4,6-bis(dibutylamino)-s-triazine,
(48) oligomeric condensate of 4,4′-hexamethylenebis(amino-l-acyloxy-2,2,6,6-tetramethyl-piperidine) and 2,4-dichloro-6-[(1-acyloxy-2,2,6,6-tetramethylpiperidin-4-yl)butylamino]-s-triazine end-capped with 2-chloro-4,6-bis(dibutylamino)-s-triazine,
(49) product obtained by reacting (a) with (b) where (a) is product obtained by reacting 1,2-bis(3-aminopropylamino)ethane with cyanuric chloride and (b) is (2,2,6,6-tetramethylpiperidin-4-yl)butyl-amine,
or a mixture thereof.

14. The plastic article of claim 13, wherein the HALS comprises (2) bis(2,2,6,6-tetramethylpiperidin-4-yl) sebacate, (44) reaction product of maleic acid anhydride-C₁₈-C₂₂-α-olefin-copolymer with 2,2,6,6-tetramethyl-4-aminopiperidine, or a mixture thereof.

15. The plastic article of claim 12, wherein the HALS is present at an amount ranging from about 0.01 wt % to about 0.4 wt % based on the total weight of the plastic article.

16. The plastic article of claim 1, wherein a weight/weight ratio of the thioester additive to the phenolic antioxidant ranges from about 5:1 to about 1:5.

17. The plastic article of claim 1, wherein a weight/weight ratio of the thioester additive to the phosphite stabilizer ranges from about 5:1 to about 1:5.

18. The plastic article of claim 1, wherein the plastic article further comprises at least one of an acid scavenger, an anti-scratch additive, a dye, or a mixture thereof.

19. The plastic article of claim 1, wherein the plastic article exhibits a yellowness index delta, at 168 hours, in gas fade testing performed according to AATCC 23 ranging from about 1.2 to about 1.9, from about 1.3 to about 1.8, or from about 1.4 to about 1.6.

20. The plastic article of claim 1, wherein the plastic article exhibits a long term stability at 150° C. evidenced by hours to failure ranging greater than about 500 hours, greater than about 550 hours, greater than about 600 hours, greater than about 650 hours, or greater than about 700 hours, tested in accordance with ASTM D3012.

21. The plastic article of claim 1, wherein the plastic article exhibits 60° gloss retention, after 2000 hours, ranging from about 40% to about 70%, from about 45% to about 68%, or from about 50% to about 67%, tested in accordance with SAE J2412.

22. A stabilizer additive composition, comprising:
i) a thioester additive having the chemical structure: 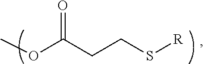
wherein R is a C₆-C₁₈ hydrocarbyl group;
ii) a phenolic antioxidant; and
iii) an organophosphorus stabilizer.

23-37 (canceled)
